(19) United States
(12) Patent Application Publication
(10) Pub. No.: US 2012/0330855 A1
(43) Pub. Date: Dec. 27, 2012

(54) Military Occupations and Skills Management System

(75) Inventors: Mark W. Maxwell, San Carlos, CA (US); Vicki C. Mar, San Carlos, CA (US); Steven M. Fogel, San Carlos, CA (US); Terry D. Howell, Forest Grove, OR (US); Chris R. Kosmakos, Martinez, CA (US); Douglass Matthews, Prague (CZ)

(73) Assignee: MONSTER WORLDWIDE, INC., New York, NY (US)

(21) Appl. No.: 13/168,874

(22) Filed: Jun. 24, 2011

(51) Int. Cl. G06Q 10/00

(52) U.S. Cl. 705/320

(57) ABSTRACT

Systems and methods are provided for translating military occupations and MOS codes into civilian skills and civilian occupations. The military duties associated with a MOS code are mapped to equivalent or relevant civilian skills and civilian occupations. A user's selection of MOS codes, subspecialties, trainings, licenses or work experiences are mapped to one or more civilian skills, which in turn can be mapped to one or more civilian occupations and used to generate a set of matching civilian jobs.

### BACKGROUND

1. Field of Art

The present invention relates to computer implemented database systems for translating military occupations to civilian skills and occupations.

2. Description of Related Art

Generally, military occupations are unique to the military, and each military occupation is assigned a military occupational specialty (MOS) code. The MOS code is typically associated with a military branch (Army, Navy, Air Force, Marine Corps, and Coast Guard), and a set of military job duties, subspecialties, and optionally have specific requirements, experiences, rank, and pay grade. Outside the military, it can be difficult for military personnel to search for relevant or equivalent civilian occupations that match with a military occupation and the individual's skills, experiences, or subspecialties.

Conventional methods provide a one-dimensional matching of a MOS code to one or more civilian occupations. The matching is typically based on similar tasks or requirements to perform the job. For example, an astronaut or pilot in the military can be matched to the civilian occupation of an airline pilot based on the required skill of flying an airplane. However, conventional military MOS translation services do not provide military-to-civilian occupational mappings that include industry-specific and multi-factor, hierarchical approaches for mapping military occupations and associated military job duties to civilian skills Current techniques also do not allow matching based on additional factors, such as an individual's skills, certifications, subspecialties, training, and other work related experiences.

### SUMMARY

A military occupations and skills management system allows for the creation, curation and storage of military occupations, civilian occupations and matching there between. Military occupations, in the form of MOS codes, are stored in a database, as well as civilian occupations and skills. An administrator associates specific job duties, certifications, or subspecialties of the military occupations to individual civilian skills. The MOS code itself can be mapped to one or more civilian occupations. In this manner, a multi-dimensional relational mapping is created among the MOS codes and various civilian occupations and civilian skills. The system supports multiple, industry specific sets of occupations, so that a given military occupation can be mapped to any number of different civilian occupations in different industries.

An end user accesses the military occupations and skills management system, requests translation of a MOS code, and can select one or more additional skills, subspecialties, trainings, certifications, licenses, or work experiences. A user's selected MOS code, associated military duties, additional skills, training, subspecialties, and the like (“military experience”) are used as inputs to generate a set of matching civilian skills. The matching civilian skills can be used to identify civilian occupations and jobs for the user. The civilian occupations can then be used to identify available jobs posted in jobs databases, either locally or remotely coupled to the database management system.

The military occupations and skills management system can be hosted in a variety of different platform environments, including serving as a backend for a system integrating a local job database, as well as being available as a MOS translation service exposed through an application programming interface for third party jobs database systems.

The features and advantages described in this summary and the following detailed description are not all-inclusive. Many additional features and advantages will be apparent to one of ordinary skill in the art in view of the drawings, specification, and claims herein.

### BRIEF DESCRIPTION OF THE DRAWINGS

FIG. 1 is a high-level block diagram of a system environment including a military occupations and skills management system, in accordance with an embodiment of the invention.

FIG. 2 is a high-level block diagram of a skills translator engine, in accordance with an embodiment of the invention.

FIG. 3 is a high-level block diagram of a database schema for the military occupations and skills management system.

FIG. 4a is an example of a user interface for a skills translator admin console, in accordance with an embodiment of the invention.

FIG. 4b is an example of search results for a military occupation, in accordance with an embodiment of the invention.

FIGS. 5a and 5b are examples of user interfaces for viewing and editing a record of a military occupation, in accordance with an embodiment of the invention.

FIG. 6 is an example of a user interface for creating a record of a military occupation, in accordance with an embodiment of the invention.

FIG. 7 is an example of a user interface for searching for a subspecialty, in accordance with an embodiment of the invention.

FIG. 8 is an example of search results for a subspecialty, in accordance with an embodiment of the invention.

FIG. 9 is an example of a user interface for viewing and editing a record of a subspecialty, in accordance with an embodiment of the invention.

FIG. 10 is an example of a user interface for creating a record for a subspecialty, in accordance with an embodiment of the invention.

FIG. 11 is an example of search results for a civilian occupation, in accordance with an embodiment of the invention.

FIG. 12 is an example of a user interface for viewing and editing a record of a civilian occupation, in accordance with an embodiment of the invention.

FIG. 13 is an example of a user interface for creating a record for a civilian occupation, in accordance with an embodiment of the invention.

FIG. 14 is an example of a user interface for searching for a civilian skill, in accordance with an embodiment of the invention.

FIG. 15 is an example of a user interface for viewing and editing a record of a civilian skill, in accordance with an embodiment of the invention.

FIG. 16 an example of a user interface for creating a record for a civilian skill, in accordance with an embodiment of the invention.

FIG. 17 is an example of a user interface for searching for a certification or a license, in accordance with an embodiment of the invention.

FIG. 18 is an example of search results for a certification or a license, in accordance with an embodiment of the invention.

FIG. 19 is an example of a user interface for viewing and editing a record for a certification or a license, in accordance with an embodiment of the invention.

FIG. 20 is an example of a user interface for creating a record for a certification or a license, in accordance with an embodiment of the invention.

FIG. 21 is an example of a user interface for searching for a military training, in accordance with an embodiment of the invention.

FIG. 22 is an example of search results for a military training, in accordance with an embodiment of the invention.

FIG. 23 is an example of a user interface for viewing and editing a record of a military training, in accordance with an embodiment of the invention.

FIG. 24 is an example of a user interface for creating a record of a military training, in accordance with an embodiment of the invention.

FIG. 25 is an example of a user interface for managing employer content, in accordance with an embodiment of the invention.

FIG. 26 is an example of a user interface for editing employer content, in accordance with an embodiment of the invention.

FIG. 27 is a flow diagram for the skills translation process, in accordance with an embodiment of the invention.

FIG. 28 is an example of a user interface of a skills translator home page, in accordance with an embodiment of the invention.

FIG. 29 is an example of search results for a query of a military occupation, in accordance with an embodiment of the invention.

FIG. 30 illustrates an exemplar screen shot of a user interface for adding additional subspecialties and specialized trainings to a user's search, in accordance with an embodiment of the invention.

FIG. 31 illustrates an exemplar screen shot of a user interface for adding additional experiences, work skills, and an education level to the user's search, in accordance with an embodiment of the invention.

FIG. 32 is an example of a user interface for selecting a military occupation, in accordance with an embodiment of the invention.

FIG. 33 is an example of a user interface showing search results for a military occupation, in accordance with an embodiment of the invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

Embodiments of the present invention provide systems, methods, and computer-readable storage media for matching military occupations to civilian occupations based on a multi-factor, hierarchical mapping of skills, certifications, specialties or trainings.

Methods and systems are provided for matching military occupations and associated military job duties to civilian skills and civilian occupations. The mapping of military occupations and military job duties to civilian skills allows for a relational linking among the various military occupations and civilian occupations and skills Embodiments also include mapping of subspecialties, certifications, other experiences, trainings, and the like for matching military occupations to civilian occupations.

A military occupation is associated with a military service (or branch), has an assigned MOS code, and a set of associated military job duties. A military job duty is a task or ability or other experience required to perform a military occupation. Military job duties can be specific to a military job or occupation. For example, a combat officer could have military job duties such as gathering and evaluating intelligence on enemy strength and position, developing offensive and defensive battle plans, coordinating missile strikes, or leading a team of forces into missions. Certain military job duties can include generally applicable abilities such as developing and implementing administrative plans, directing operations, or preparing and examining financial records and budgets. Other military job duties can include operating particular types of industrial equipments, communication devices, and servicing and repairing particular vehicles.

The military job duties are translated to corresponding or related civilian skills. For example, the military occupation for an astronaut in the air force has the MOS code “13A1A” and can be translated to civilian skills, such as “navigate flight of multi-engine airplane.” Additional subspecialties, certifications, trainings, or work experiences can be associated with the military occupation or can be added as an input by the user.

A civilian occupation is any non-military occupation having a set of associated civilian skills. The civilian occupation can have associated subspecialties, certifications, trainings, and/or experiences. A federal occupation is a type of civilian occupation for which the employer is the federal government. A federal occupation also includes associated civilian skills, which can be matched to military job duties and military occupations.

The term “job” refers to a specific job opening or available position and is categorized under a particular occupation. For example, whereas a “Chief Financial Officer” is an occupation, the opening for the CFO position at a specific company is a job. When a military occupation is matched with a civilian occupation in the military occupations and skills management system, a list of available civilian jobs that fall under the civilian occupation can be provided by access to a jobs database. For example, a list of available commercial airline pilot jobs can be provided when a MOS code is matched with the civilian occupation of a pilot.

The term “skills” refers to any abilities that are needed for a particular occupation or job. Skills can include competencies, knowledge, abilities, or a combination thereof. Civilian skills are skills that are associated with a civilian occupation and are mapped to military occupations. Examples of civilian skills can include managing a team, analyzing data, organizing records, updating files, programming in a specific computer language, maintaining a budget of expenses, speaking a foreign language, operating a particular machine or equipment, resolving conflict, gathering data, or managing operations.

The terms “user's experiences” or “user experience” include the user's military occupation (MOS code), associated military job duties, subspecialties, trainings, certifications, licensures, previous work experiences, or other inputs added by the user. The user's experiences are used as a set of user's inputs and matched to civilian skills and occupations.

A user refers to, but is not limited to, an individual, entity, group, corporation, third party, client or administrator who interacts with, manages, edits, or creates content in the system. The user can be associated with the military, civilian, private, third-party or federal sectors.

An administrator (“admin”) is a type of user with special permissions to access, view, edit, manage, and create content in the system. An admin can use a designated log-in ID or password (admin credentials) to access the system or logs-in through a designated admin console web page. One or more admins can manage the system. For example, there can be an admin for the military occupational data and an admin for the civilian occupational data.

An employer is a third-party user that provides civilian occupations, civilian jobs, and civilian skills. The employer can provide civilian occupations, jobs, and skills for matching to military occupations.

A record is a database storage mechanism for storing data about an occupation, skill, specialty, subspecialty, or training, etc. The record contains input fields for entering data. The record can be searched, edited, and stored in one or more internal or external databases of the system.

System Architecture

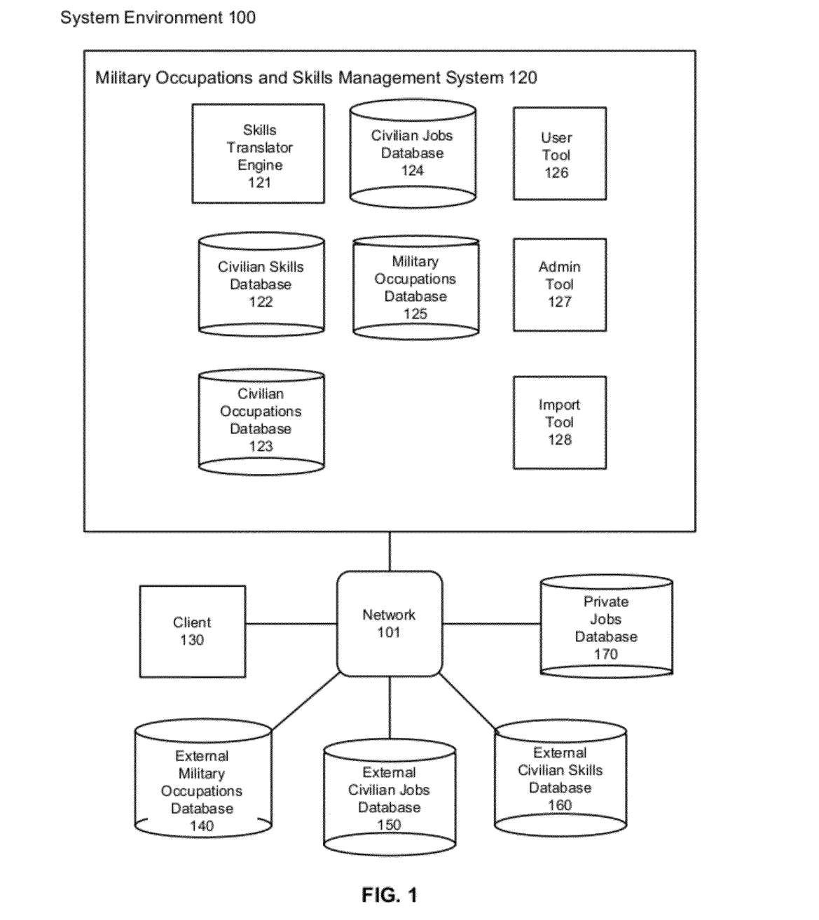

FIG. 1 is a high level block diagram of a system environment 100 in accordance with one embodiment. As illustrated in FIG. 1, the environment 100 includes a network 101, military occupations and skills management system 120, a client 130, an external military occupations database 140, an external civilian jobs database 150, an external civilian skills database 160, and a private jobs database 170. The military occupations and skills management system 120 includes a skills translator engine 121, a civilian skills database 122, a civilian occupations database 123, a civilian jobs database 124, a military occupations database 125, a user tool 126, an admin tool 127, and an import tool 128.

The network 101 represents the communication pathways between the military occupations and skills management system 120, the external databases 140, 150, 160, 170, and the client 130. In one embodiment, the network 101 is the Internet and uses standard communications technologies and/or protocols. The network 101 can also utilize dedicated, custom, or private communications links that are not necessarily part of the Internet.

The environment 100 includes a client 130. The client 130 is a computer or other electronic device used by one or more users to perform activities including accessing the military occupations and skills management system 120 and requesting translation of a military occupation into one or more civilian occupations. A user accesses the military occupations and skills management system 120 via the client 130 to search, query, view, edit, or manage the records or data associated with the military occupations and skills management system 120.

The environment 100 comprises an external military occupations database 140. The external military occupations database 140 stores information and records of a plurality of military occupations, the associated MOS codes, and/or related military job duties. The external military occupations database 140 can comprise a listing of all of the current military occupations, associated descriptions, and MOS codes. An example of an external military occupations database 140 is the database of military occupations maintained by the U.S. Department of Defense.

In addition, the environment 100 comprises an external civilian jobs database 150. The external civilian jobs database 150 can include information and records for a plurality of civilian jobs. These job openings can be created, compiled, and managed by a third party or other entity. Each record for a job can include a description, requirements, skills, experience, pay, or other relevant information. The records are stored in the external civilian jobs database 150 and can be accessed by the military occupations and skills management system 120.

The environment 100 also includes an external civilian skills database 160. The external civilian skills database 160 provides a comprehensive collection of civilian skills associated with various civilian jobs and occupations. Each skill record includes a name, description, field of industry, technical or educational requirements, as well as associations (relationships) to related skills. The civilian skills can be associated with a civilian occupation and/or a military occupation. The environment 100 can include a private jobs database 170. The private jobs database 170 includes a listing of civilian jobs created, compiled, or managed by a private entity or corporation. The list of jobs is searchable, and each job can be associated with one or more civilian occupations.

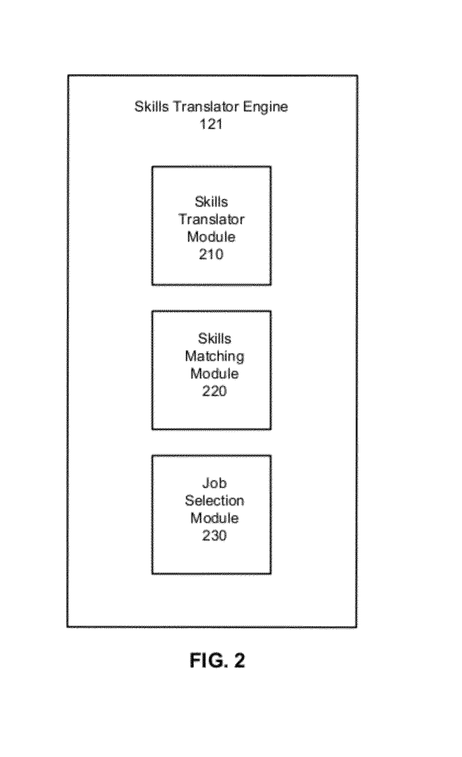

Moreover, the military occupations and skills management system 120 includes a skills translator engine 121, which provides for the creation, mapping, and matching of military occupations to civilian skills and occupations. The skills translator engine 121 is described in detail in FIG. 2.

Various internal databases can be associated with the military occupations and skills management system 120. An internal civilian skills database 122 can store records of a plurality of civilian skills, and can have a similar or different schema for representing skills as the external civilian skills database 160. The civilian skills database 122 can include a plurality of skills associated with various civilian jobs, and each skill can be associated with one or more civilian occupations and/or military occupations. In some embodiments, the internal civilian skills database 122 can also store records for subspecialties, trainings, licenses, certifications, etc. that are associated with a civilian occupation or inputted by a user of the system 120.

The internal civilian occupations database 123 stores a plurality of civilian occupations. The civilian occupations can be associated with various civilian skills and military occupations.

The internal civilian jobs database 124 can store information about available job openings, and can have similar or different schema for representing civilian jobs as the external civilian jobs database 160. The civilian jobs can be compiled and managed as records by the admin. Each civilian job can be associated with a civilian occupation.

Moreover, the military occupations and skills management system 120 comprises a military occupations database 125. The military occupations database 125 stores information and records of a plurality of military occupations, the associated MOS codes, and/or related military job duties. The military occupations database 125 can comprise a listing of military occupations that is cumulative to or adds to the military occupations in the external military occupations database 140.

In some embodiments, the military occupations and skills management system 120 can include a user tool 126. The user tool 126 enables a user of the system to access the military occupations and skills management system 120 via the client 130 and provides a user interface for the user to interact with the skills translator engine 121 and associated databases.

The military occupations and skills management system 120 may also include an admin tool 127. The admin tool 127 provides an interface for an admin to create, edit, delete, update, and manage (collectively, “curate”) the data processed by the skills translator engine 121 and to access data within various external and internal databases, and is one means for performing these functions.

The import tool 128 allows the import of data from various external databases, such as the external military occupations database 140, the external civilian jobs database 150, the external civilian skills database 160, and/or the private jobs database 170, and is one means for performing these functions. The import tool 128 responds to instructions from the skills translator engine 121, the user tool 126, or admin tool 127 to retrieve data from multiple databases.

FIG. 2 illustrates the skills translator engine 121. The military skills translation engine 121 comprises a skills translator module 210, a skills matching module 220, and a job selection module 230.

The skills translator module 210 receives a request to translate (or “match”) a military occupation into one or more civilian occupations. The skills translator module 210 receives a MOS code or a name of a military occupation, whether inputted by a user, or received via an application programming interface. If a name of the military occupation is received (e.g., combat officer), the skills translator module 210 outputs with a matching MOS code or list of possible MOS codes that match the inputted military occupation. Where the skills translator module 210 receives a selected MOS code, it can output a set of corresponding military job duties associated with the MOS code. For example, a MOS code for a Technical Engineering Specialist (“21T”) could be associated with the following military job duties: “conduct land surveys,” “engineer maps of terrain,” or “prepare detailed plans and drawings for construction projects.” In another example, the MOS code for an astronaut/pilot in the Air Force is “13A1A” and is associated with the following military job duties: “commands space shuttle missions,” “pilots space shuttle,” “accomplishes on-orbit duties,” “operates Department of Defense (DoD) payloads,” and “provides manned space flight consultation to DoD activities and other government agencies.”

The skills matching module 220 receives as input one or more military MOS codes, for example as output by the skills translator module 210, and matches these MOS codes with corresponding civilian skills, and is one means for performing this function. In some embodiments, the military occupations and civilian skills have been previously associated or linked together. In certain embodiments, an admin performs the task of associating or linking military occupations to civilian skills, which is described in detail herein. In addition, the skills matching module 220 can search the civilian skills database 122 for a plurality of similar or equivalent civilian skills based on key words or similar terms with the MOS code(s), and then automatically establish links between the military occupation and civilian skills. In some embodiments, the civilian skills are chosen by relevance to the military occupation.

The skills matching module 220 also matches job duties for a military occupation directly to civilian skills. For example, general job duties can be easily mapped to civilian skills, such as organization, administration, or computer skills. For example, if a MOS code requires duties for performing repair and maintenance tasks (e.g., for a construction mechanic), then the skills matching module 220 can search for similar civilian skills that relate to repair or maintenance. In another example, a MOS code for a finance officer in the military would require duties for disbursing, collecting and accounting for public funds. This set of military job duties could be matched with similar civilian skills for accounting, disbursement, and management of finances. In another embodiment, an admin can perform the task of matching job duties associated with a military occupation directly to civilian skills. The skills matching module 220 can also match duties for a military occupation that do not translate directly to a set of civilian skills, but require a level of abstraction or analysis. For example, a gunner's mate in the Coast Guard would have military job duties in handling small arms weapons and ammunition. The majority of military job duties required for a gunner's mate would not equate or have direct applicability to civilian skills. However, given the gunner's ability to handle and repair weapons, civilian skills in mechanics, installation and repair of machinery or electronics may be mapped to the military occupation. In yet another example, the occupation of a marine aide in the military may have the following military duties: assist with the care, cleanliness and order of assigned quarters, uniforms and military personal equipment; perform as point of contact in the officer's quarters; assist in purchasing, preparing, and serving food and beverages in the officer's assigned quarters; and accomplish tasks which aid the officer in performing his military and official responsibilities, including providing security for the quarters and providing administrative assistance. The skills matching module 220 can translate the military job duties for a marine aide into civilian skills for an administrative assistant (e.g., providing high-level administrative support by conducting research, preparing statistical reports, handling information requests, and performing clerical functions, such as preparing correspondence, receiving visitors, arranging conference calls, and scheduling meetings). Thus, military duties for a military occupation can be matched by the skills matching module 220 to civilian skills based on key words, similar terms or functions, or a previous relational linking of the military occupation or job duties to civilian skills.

When a military occupation has been matched to one or more civilian skills, the skills matching module 220 can identify one or more civilian occupations that correspond with the one or more civilian skills. In one example, a set of civilian skills can include the “ability to fly multi-engine aircraft,” which would map directly to several civilian pilot occupations. In another embodiment, the skills matching module 220 can also retrieve a plurality of civilian occupations from the civilian occupations database 124 that directly map to the MOS code. For instance, the MOS code “13A1A” can be relationally linked to civilian occupations for an “airplane pilot,” “copilot,” or “flight engineer.” Thus, the skills matching module 220 identifies one of more civilian occupations that map to the set of identified civilian skills.

In addition, the skills translator module 210 can receive other user inputs, such as military certifications or licenses from a user. The skills translator module 210 sends the military certifications and licenses to the skills matching module 220 for processing. The skills matching module 220 maps the military certifications or licenses to similar, relevant, or equivalent certifications or licenses associated with civilian occupations. For instance, if a user inputs a nursing certification, along with the MOS code “66P” for a “Family Nurse Practitioner,” the skills matching module 220 can match the nursing certification with those required for a civilian nurse practitioner. Other examples of certifications include Emergency Medical Technician certifications, e.g., Basic, First Responder, Registered Medical Assistant (RMA), and Certified Medical Assistant (CMA) certifications.

The skills translator module 210 can also receive subspecialties as inputs. The skills translator module 210 sends the subspecialties to the skills matching module 220, and the skills matching module 220 can map the subspecialties to civilian skills. For example, a user may input a subspecialty (“aircraft publication manager”) for a specialized experience as an air force pilot, or educational subspecialties for graduate education or course work. Examples of subspecialties include Force Protection Officer, Pay Agent, Recruiter, Repair and Utilities Coordinator.

Similar mappings can be performed by the skills matching module 220 for a user's military training. Examples of military training include classroom instruction (courses in the applicable field of work), field instruction, or instruction from training schools based on the military service (i.e., Army Advanced Individual Training School, Marine Corps MOS School, Navy Advanced Individual Training, Air Force Technical Training, or Coast Guard “A” School). Other examples of military trainings include the following: Advanced Leaders Course (ALC) (BNCOC) Phase 1, Interrogator Basic Noncommissioned Officer (NCO), 91S Advanced Individual Training (AIT), Air Traffic Control Operator, and Advanced Leaders (ALC). These training credentials can be mapped to similar or equivalent training requirements for civilian occupations. For example, many of the military training courses can be applied to college credit. Certain military training courses cover topics applicable to civilian occupations, such as technology, safety and law enforcement, environmental operations, or business administration.

Additional non-military skills and previous work experiences outside of the military context can be inputted by the user for matching by the skills matching module 220. For instance, if a combat officer previously worked as an administrative assistant, then the combat officer can input those administrative skills, such as performing general office duties, preparing memos or letters, managing executives' schedules, or compiling research, for matching to a civilian occupation.

The set of military job duties, subspecialties, trainings, and other inputs of the user can be referred to as a set of user's experiences. In one embodiment, the user's experiences (which can include a MOS code, corresponding military job duties, subspecialties, trainings, certifications, licenses, other skills, or experiences) are analyzed together and matched to civilian skills and civilian occupations. In one embodiment, the skills matching module 220 ranks the skills or attributes weighted values to each of the skills. Certain inputs can be assigned a higher rank, score, or value compared with other inputs, such as certifications or trainings. For instance, the ability to fly an airplane could be given a higher value than a certification for computer skills, depending on the occupation. The skills matching module 220 can score the inputs of the user's experiences (MOS code, military job duties, subspecialties, trainings, and other inputs) as an aggregate of the weighted values of the each of the inputs.

User inputs can also have different weighted values depending on the various experiences and occupations. Weighted values can be applied to the associations between 1) a user's experiences (MOS, subspecialty, training, etc.) and civilian skills, or 2) civilian skills and civilian occupations to reflect the relative importance of those associations, since skills are the intermediary between a user's experiences and equivalent civilian occupations. Separate weights may be considered for the association between a user's experiences to civilian skills and the association between a civilian skill and a resulting translated civilian occupation. During translation from a MOS to equivalent civilian occupations, the weighted values can be summed to determine a relevance score for the equivalent occupations. The relevancy score provides a ranking of the equivalent occupations based on the number and importance of the skills the user has associated with those occupations. The higher the relevancy score is for an occupation, the more it matches the important skills of a user's experiences. The ranked occupation list can be cropped to include only the most relevant occupations for use in a job search. In one embodiment, the occupation relevancies could be used to help rank the job listings returned by a job search.

The skills matching module 220 can also generate a matching score to measure the degree of matching among the user's experiences and a set of civilian skills. In one embodiment, the matching score must meet a pre-determined threshold in order for the civilian skills to be matched to the user's experiences. The matched civilian skills can then be used to generate a list of matching civilian occupations and jobs.

In addition, the job selection module 230 receives one or more matched civilian occupations from the skills matching module 220. The job selection module 230 searches the civilian jobs database 124, the external civilian jobs database 150, or the private jobs database 170 for job openings that match the one or more of the civilian occupations. For example, if the job selection module 230 receives the civilian occupation of “teacher,” the job selection module 230 can search one or more of these databases for available jobs that are related to a teaching occupation. The job selection module 230 can then present a set of relevant jobs to the user.

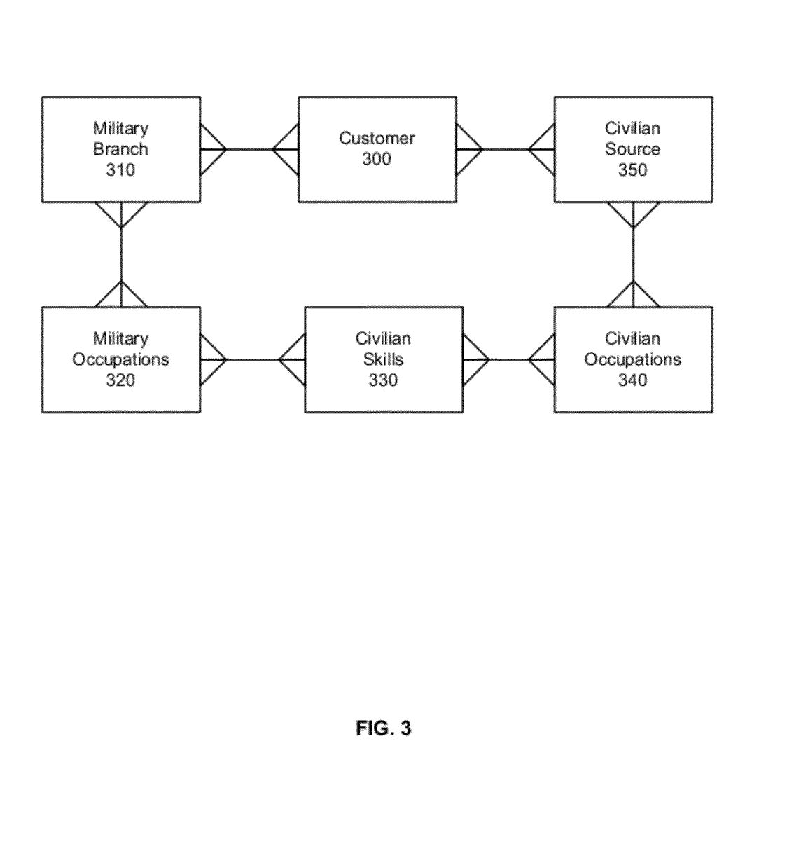

FIG. 3 is a high-level block diagram of an exemplary schema for the military occupations and skills management system. The schema comprises a customer 300 for which the military occupations and skills management system 120 is implemented. The customer 300 can refer to one or more third parties, such as a corporate entity, business, organization, federal entity, employer, etc. The customer 300 sets the framework for the types of civilian occupations and civilian jobs are matched to military occupations. The customer 300 is described with various attributes, such the customer entities' name, location, relevant contact, corporate, and account information. Each customer 300 is associated with a plurality of military branches 310. In one example, the military branch 310 includes the Army, Navy, Air Force, Marine Corps, and Coast Guard, and a customer can be associated with any or all of these. For each military branch 310, there is a plurality of various military occupations 320, and a given occupation can be associated with multiple different branches (using different MOS codes for example). For example, a military occupation of an administrative officer can be associated with the Army and the Marine Corp branches.

Each military occupations 320 is mapped to various civilian skills 330, and each civilian skill can be mapped to different military occupations 320. Similarly each civilian skill 330 can be associated with many different civilian occupations 340, each of which can be associated with multiple different skills 330.

Each civilian occupation 340 is mapped to a civilian source 350, which refers to a broader field of work or category of civilian occupations, such as “legal” or “industry” or “engineering.” The civilian source 350 is also linked by a many-to-many mapping to the customer 300. In some examples, either the military branch 310 and military occupations 320, or the civilian source 350 and civilian occupations 340 can be replaced with a data associated with a federal source and federal occupations, or even a second civilian source and a second dataset of civilian occupation.

II. Direct Mapping of Military Occupations and Skills

1. Editing and Mapping Military Occupations

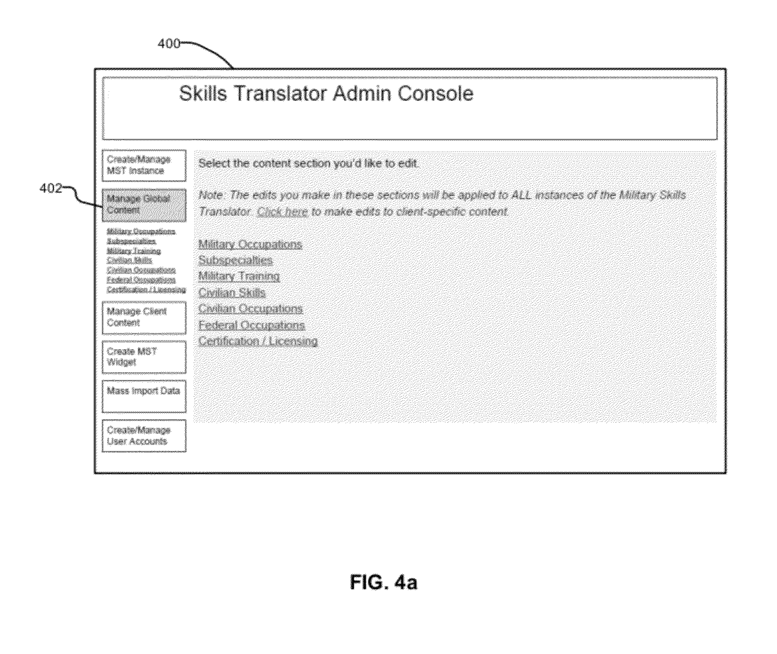

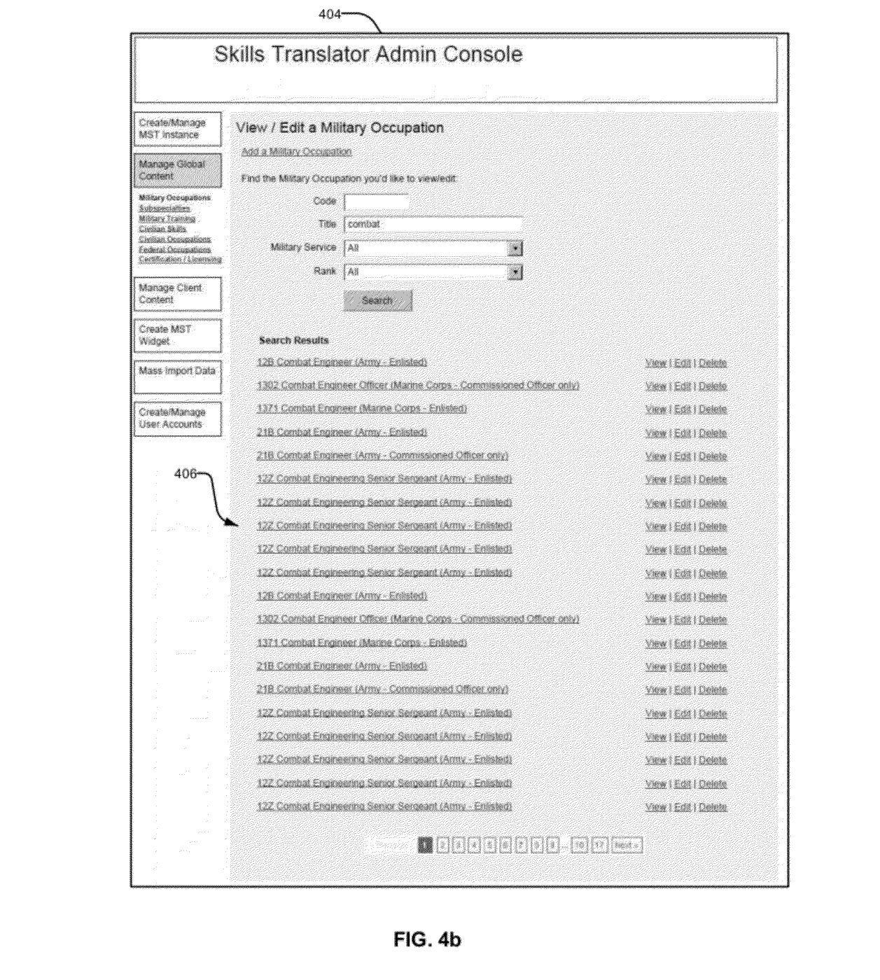

Methods and systems are provided by the military occupations and skills management system 120 for editing, viewing, and creating records of military occupations and related job duties, subspecialties, trainings, etc. FIG. 4a shows an example of a skills translator admin console 400. The admin console 400 is a user interface for the admin to access the various parts of the system, and includes an interface for creating, editing or managing the data associated with military occupations. In some embodiments, the admin can select the “Manage Global Content” tab 402 to access the pages for creating or editing content for military occupations, subspecialties, training, civilian skills, civilian occupations, federal occupations, or certifications/licensing as shown by the corresponding links in the console 400. The content can be edited to meet employer- or industry-specific needs, such as adding civilian occupations and skills that match a particular employer's specific occupations. For example, if the employer is the Department of Veterans Affairs, the civilian occupations can be adapted to include veterans' occupations and jobs. If the employer is an airplane manufacturer, such as Boeing, a different set of civilian occupations will be mapped to the military occupations.

From the admin console 400, an admin can access a page via the Military Occupations link to search for existing military occupations. FIG. 4b shows this search page 404, with search fields for a MOS code, a key word, a title of the military occupation, a military branch, or a particular rank. As shown in FIG. 4b, the search results 406 for military occupations from a search of the key word “combat” are displayed. The search results include a list of military occupations and their MOS codes that are related to the term “combat.” The administrator can select one of the military occupations, edit the information associated with the military occupation, or delete the military occupation.

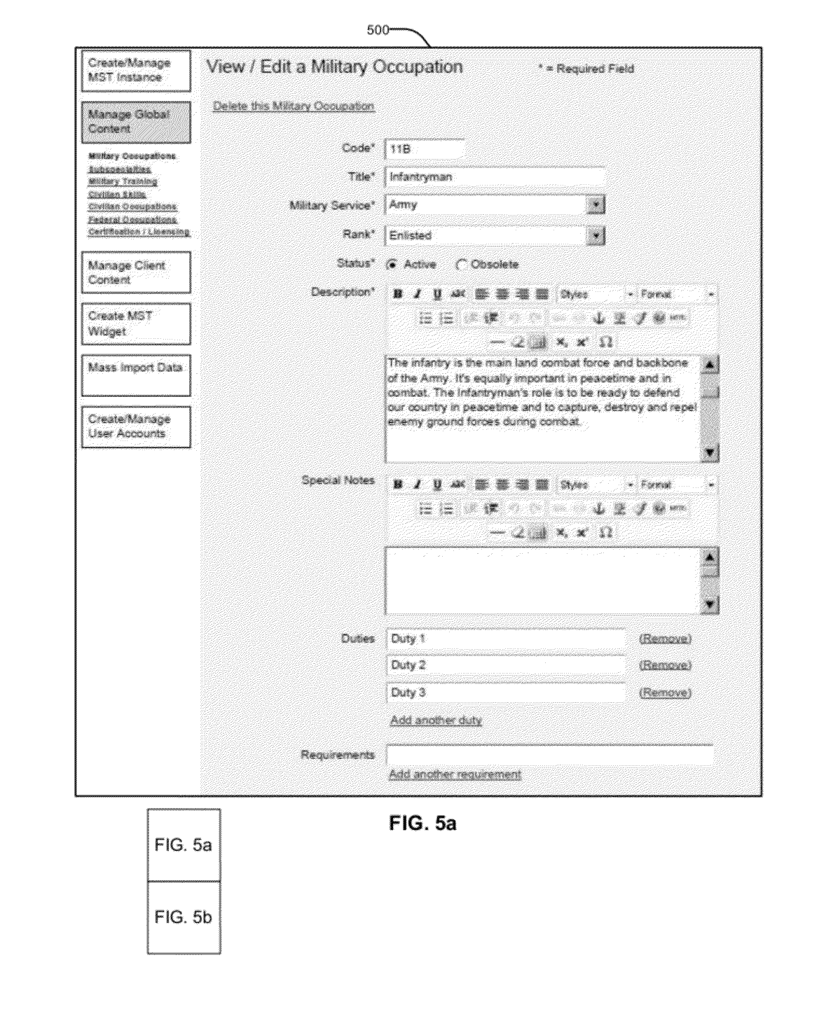

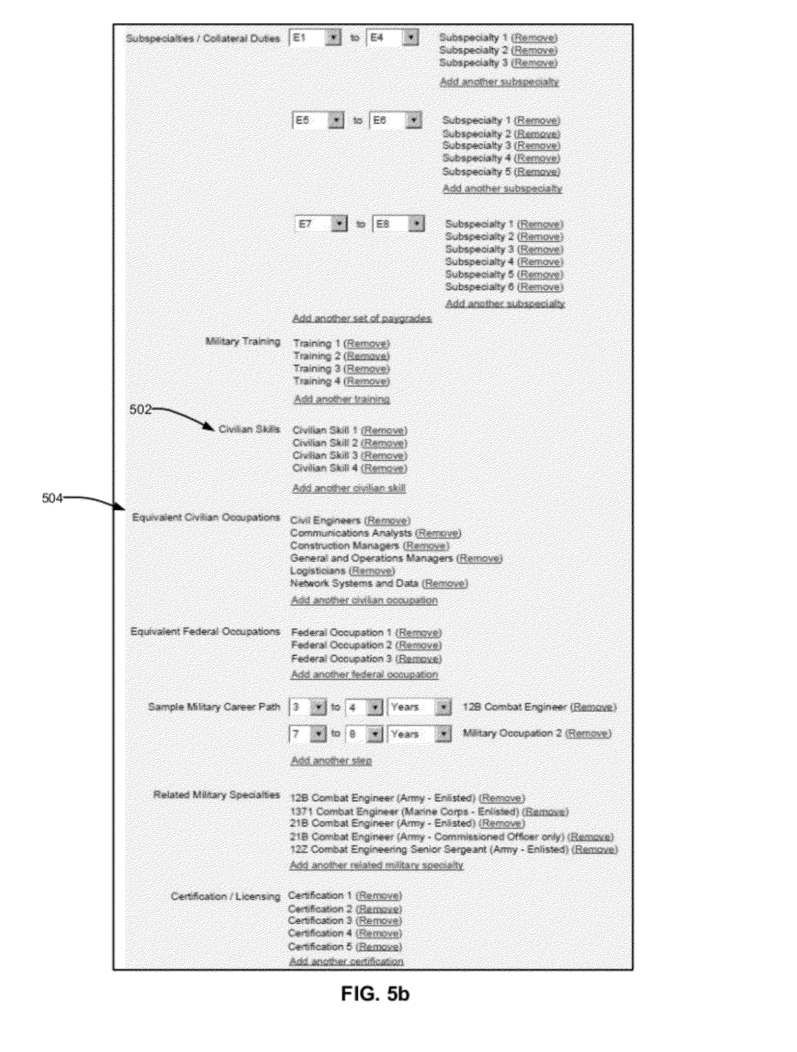

FIGS. 5a and 5b show two parts of an example user interface 500 where an admin can view and edit the data associated with a military occupation. Data can be inputted or edited for the following fields for a military occupation: MOS code, title of the military occupation, military service (branch), a description of the military occupation, duties related to the military occupation, requirements to perform the military occupation, subspecialties, collateral duties, military training, and/or certifications and licensing. In particular, each of the inputs for subspecialties, military training, and/or certifications and licensing links records for these aspects to the record for the specific military occupation. This ability to create specific linkages at the various levels of occupations, skills, training, licenses, and so forth results in a rich, hierarchical definition of each military occupation and civilian occupation.

As shown particularly in FIG. 5b, the admin can also enter civilian skills 502 and equivalent civilian occupations 504 that are associated or mapped to the military occupation. Adding a civilian skill or equivalent civilian occupation to a record for a MOS code (or military occupation) maps the civilian skill or occupation to the MOS code, creating a relationship in the underlying database records. This direct link or relationship can be used for matching purposes when the skills translation engine 121 searches for matching skills and occupations. Equivalent federal occupations can also be mapped to the military occupation.

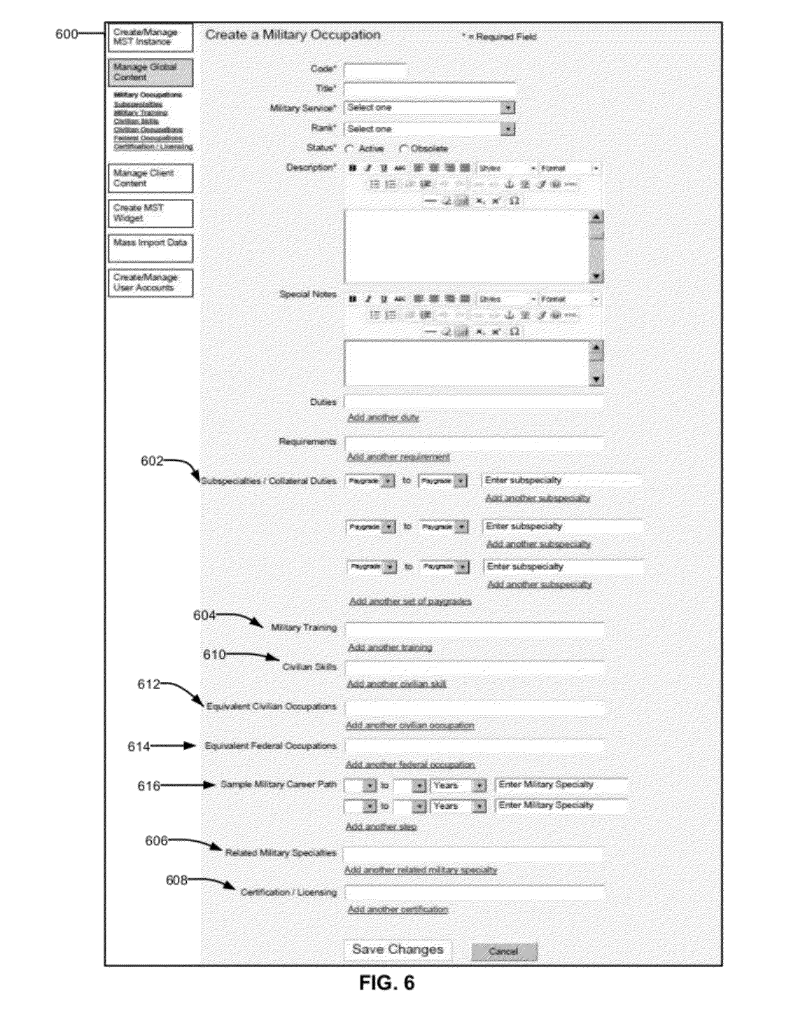

FIG. 6 illustrates an example screenshot of the admin interface 600 for creating a record of a military occupation. An admin can create a record for a military occupation by adding data to the following fields: a MOS code, title, military service, rank, status, description about the military occupation, and/or other requirements or duties. In some embodiments, the MOS code, title, military branch, rank, status, and description are required fields for creating a military occupation. The admin can also associate the military occupation with specific duties, requirements, subspecialties 602, pay grades, military trainings 604, military specialties 606, certifications/licensing 608 that are associated with the military occupation. In addition, the administrator can enter civilian skills 610 and/or civilian occupations 612 associated with the military occupation. Equivalent federal occupations 614 can also be associated with the military occupation. A sample military career path 616, including years for each military specialty, can also be added to the record for the military occupation. The mapping of subspecialties, military trainings, certifications/licensing, civilian skills and civilian occupations allows for linking of records to the record for the specific military occupation and creates a rich, hierarchical definition of each military occupation.

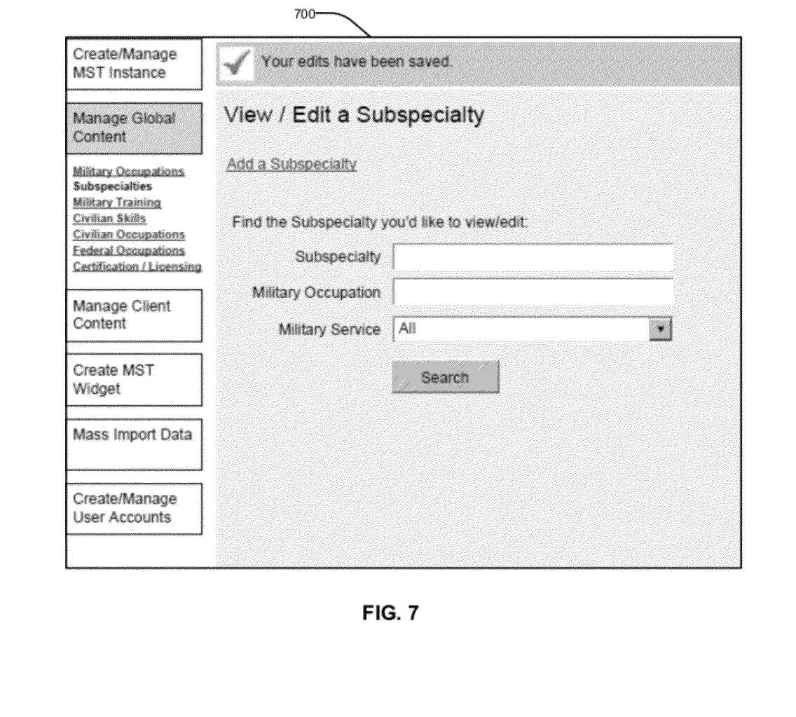

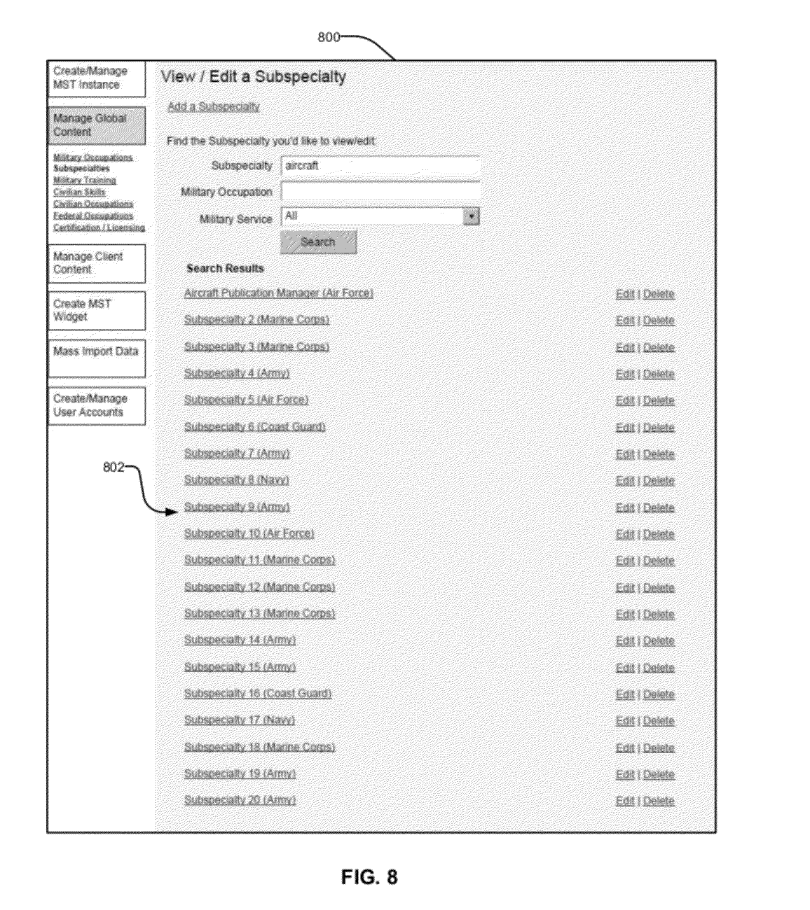

Moreover, the admin can search, view, or edit records for military subspecialties. FIG. 7 shows an example user interface 700 where an admin can enter a subspecialty (or key words) to search for existing subspecialties. The search can be based on the name of the subspecialty, an associated military occupation, or an associated military service. As shown in FIG. 8, a search of the key word “aircraft” in the subspecialty field results 802 in a list of subspecialties related to aircraft (e.g., aircraft publication manager). A subspecialty can be selected for viewing or editing, or the subspecialty can be deleted.

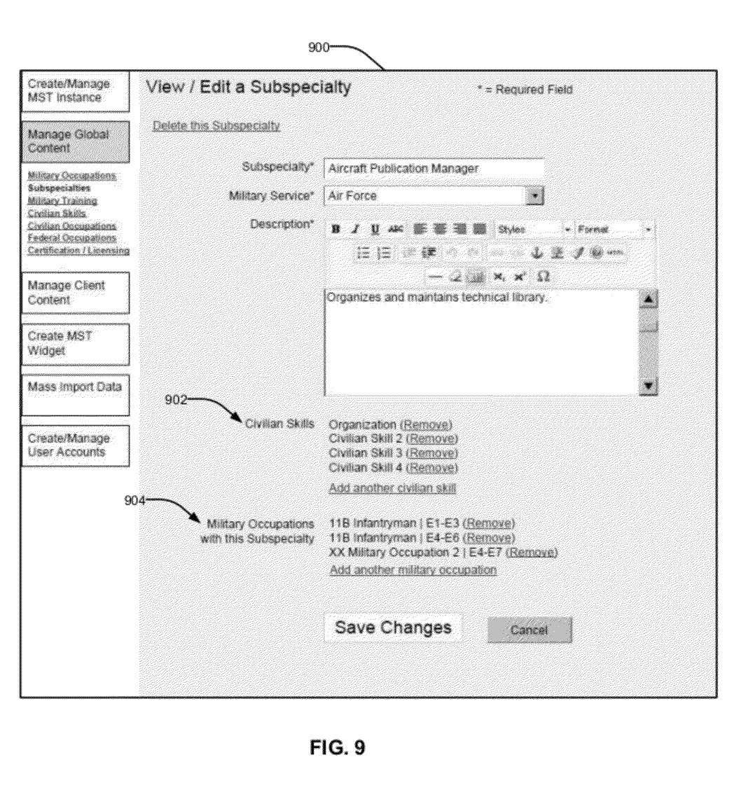

FIG. 9 illustrates a user interface 900 where the admin can view and edit a selected subspecialty. For example, the description of the subspecialty, related civilian skills, or related military occupations can be edited. As discussed above, the addition of civilian skills 902 or military occupations 904 to a subspecialty will create a relational link among the selected skills and occupations, which can be used for matching military occupations to civilian skills and occupations. For example, the subspecialty “aircraft publication manager” can be associated with civilian skills, such as organization, or military occupations related to the subspecialty, such as “11B Infantryman.”

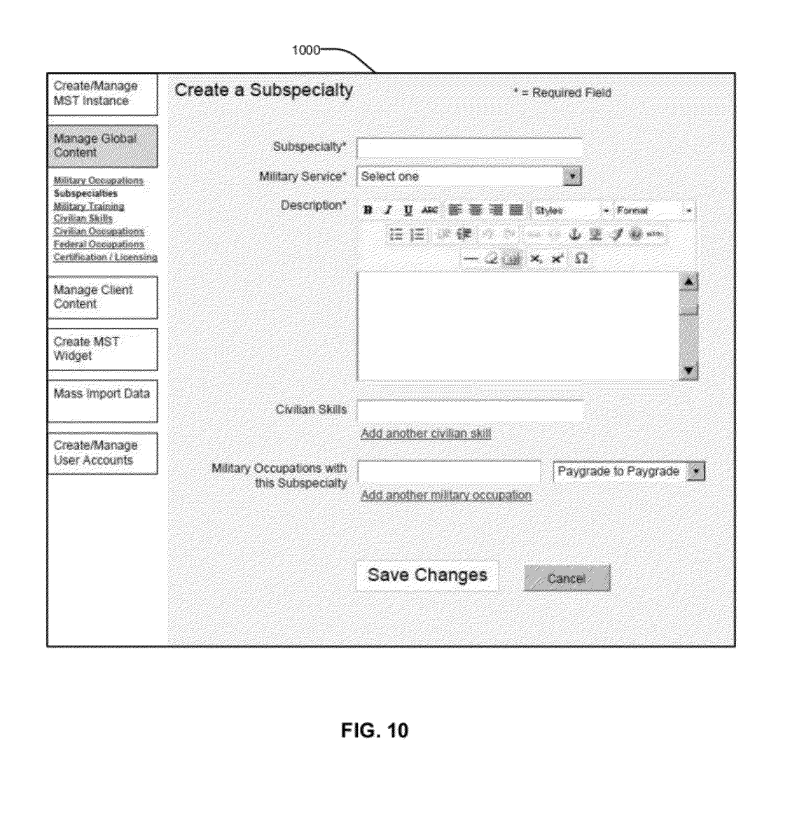

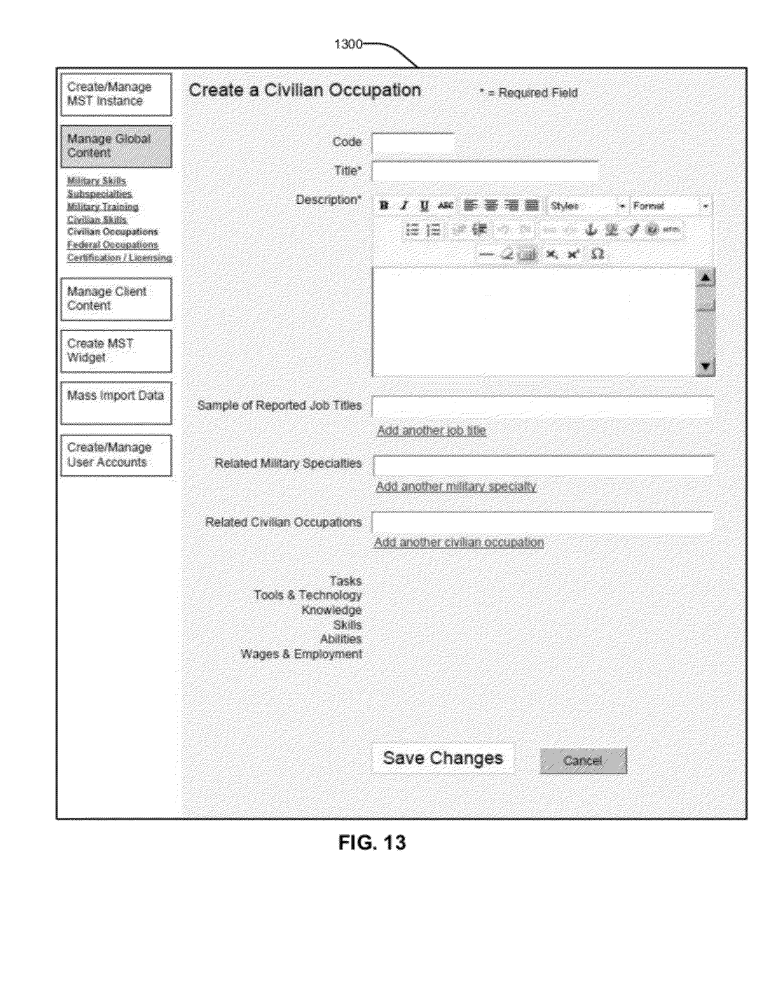

The admin can also create a record for a new subspecialty. FIG. 10 illustrates a user interface 1000 where a subspecialty can be associated with a military service, civilian skills or military occupations. The creation of a subspecialty here makes it available for linking in the military occupation interface 600 shown in FIG. 6 and the civilian occupations interface shown in FIG. 13. A description about the subspecialty can be entered in the record. Key words in the description of the subspecialty and the name of the subspecialty can be searched for matching purposes. In some embodiments, a pay grade or a range of pay grades can be associated with the military occupation and subspecialty. Adding a civilian skill or a civilian occupation to a military subspecialty maps the civilian skill or occupation to the military subspecialty.

2. Editing and Mapping Civilian Occupations and Skills

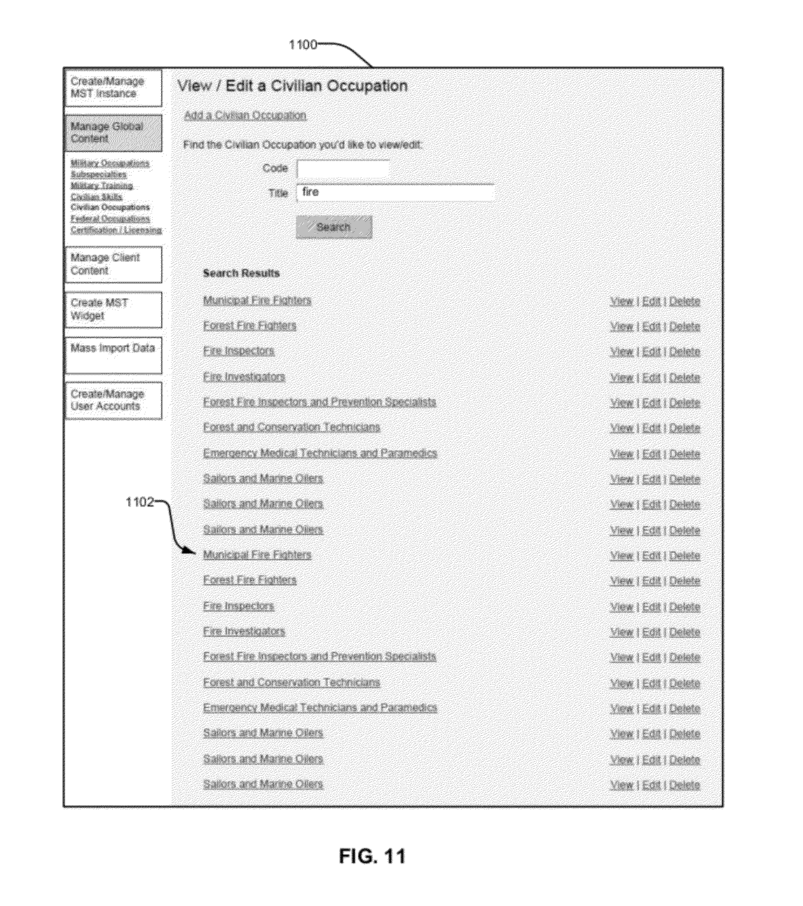

The military occupation and skills management system 120 enables civilian occupations and skills to be created, searched, and edited in a manner similar to military occupations. FIG. 11 shows an example user interface 1100 where an admin can search for existing records of civilian occupations. The search can be performed by entering key words into the title field or by entering a civilian code. For example, a search of the key word “fire” in the title field produces search results 1102 of relevant civilian occupations, such as “municipal fire fighters” or “forest fire fighters.”

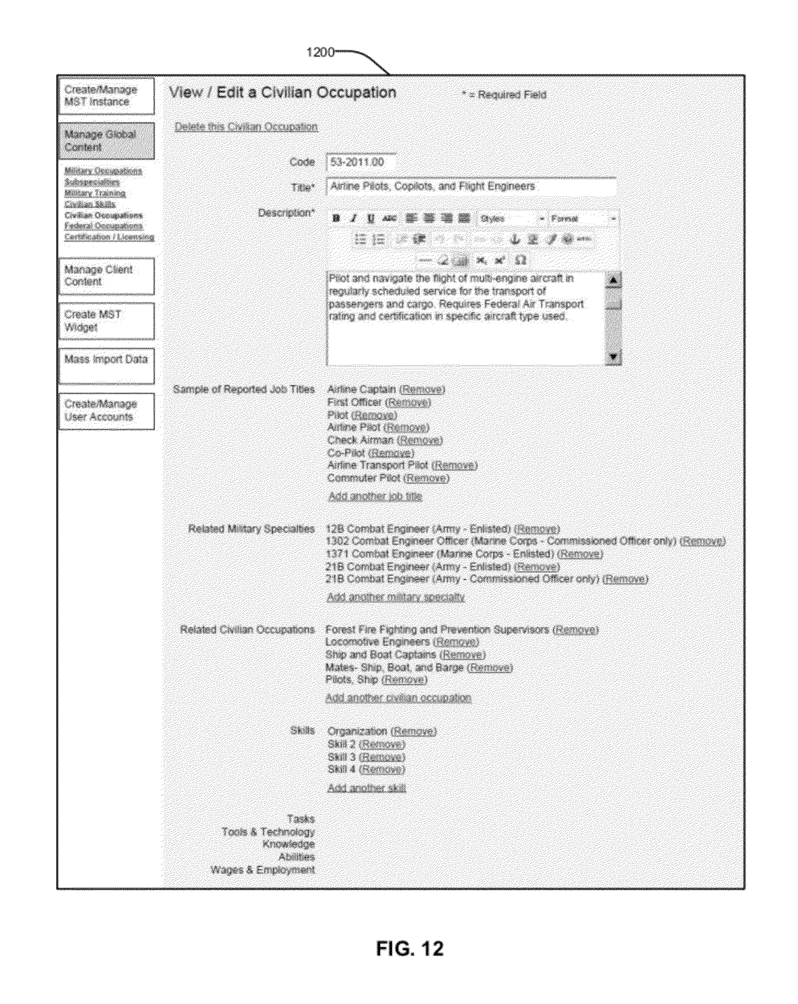

FIG. 12 illustrates a user interface 1200 for viewing and editing a record for a civilian occupation. The civilian occupation can be edited in the following fields: title, description, sample of reported job titles, related military specialties, related civilian occupations, skills, tasks, tools and technology, required knowledge, abilities, and wages and employment related to the occupation. In some embodiments, the title and description are required fields for the civilian occupation. For instance, a civilian occupation can be entitled “Airline Pilots, Copilots and Flight Engineers” with the code “53-2011.00” and have the following description: “Pilot and navigate the flight of multi-engine aircraft in regularly scheduled service for the transport of passengers and cargo. Requires Federal Air Transport rating and certification in specific aircraft type used.” Examples of job titles that are included in the civilian occupation of “Airline pilots, Copilots and Flight Engineers” are: airline captain, first officer, pilot, airline pilot, check airman, co-pilot, etc. Particularly, the admin can link the civilian occupation to previously defined military specialties, related civilian occupations, and skills. These entries establish links between the corresponding records in the various databases.

Next, the admin can create a record for a civilian occupation. FIG. 13 illustrates a user interface 1300 where an admin can create a record for a civilian occupation by entering a code, a title, and a description of the occupation. The admin can add a sample of reported job titles, related military specialties, and related civilian occupations. For example, a civilian occupation for an airplane pilot can be related to an astronaut/pilot occupation in the Air Force (MOS Code: “13A1A”). Other data can be entered in the civilian occupation record, such as related tasks, tools and technology required for performing the occupation, knowledge, skills, abilities, and wages and employment. As discussed herein, adding a related military specialty, related civilian occupation, or other skills to the record of a civilian occupation will associate and link the civilian occupation to those skills and occupations.

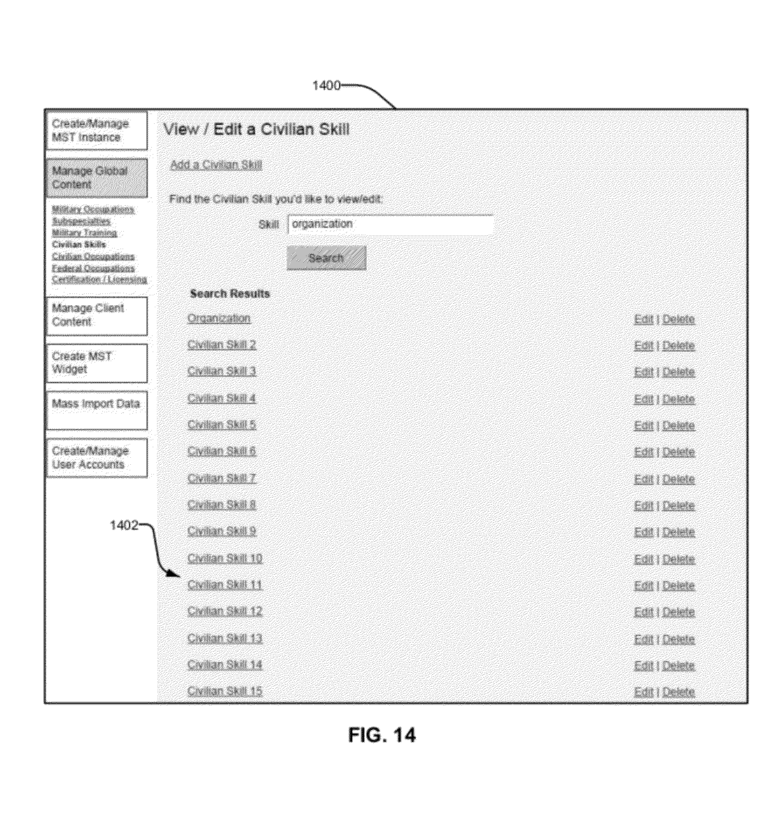

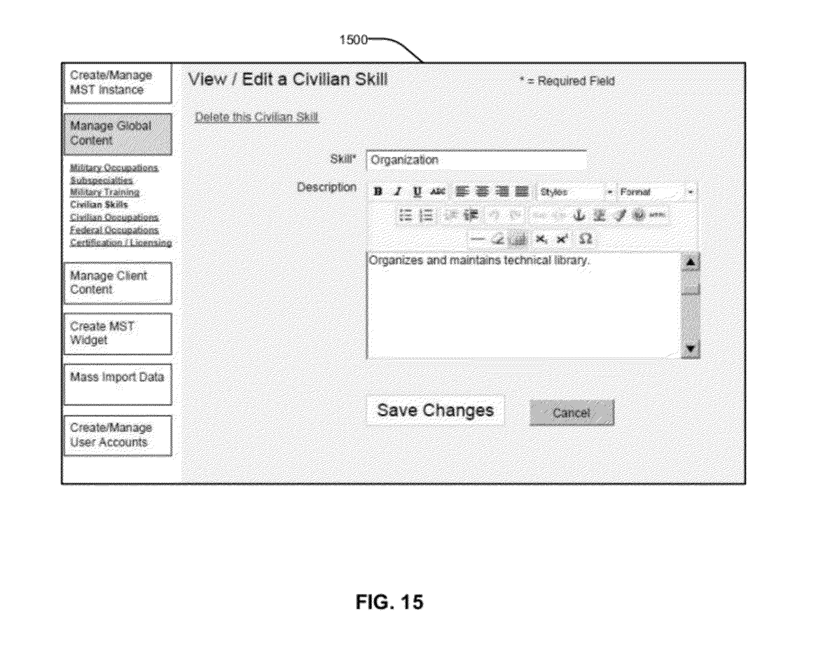

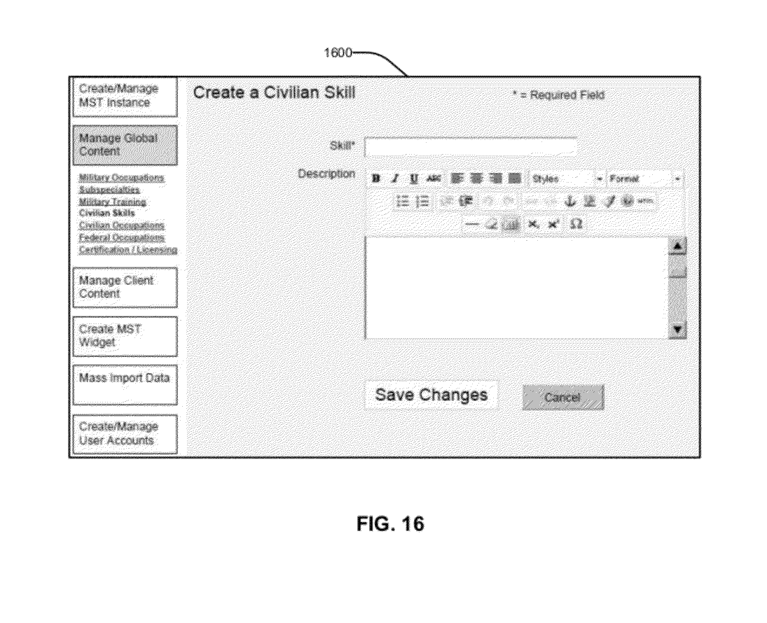

In addition, a civilian skill can be viewed and edited as a record. The civilian skill can include any skills required for a civilian occupation (or also a military occupation), such as financial reporting, human resources processes, strategic planning, surveillance techniques, conflict resolution, electronic data security, etc. In FIG. 14, a user interface 1400 is shown for searching for civilian skills based on key words, such as “organization.” A list of search results 1402 is compiled for the civilian skills that are related to the searched term. A selected civilian skill and its description can be edited and saved, as shown in the user interface 1500 in FIG. 15. In addition, a civilian skill can be created as a new record, which includes the name of the skill and a corresponding description. An example screen shot of a user interface 1600 for creating a civilian skill record is also shown in FIG. 16. Records of civilian skills can be searched and stored in the various databases 122, 150.

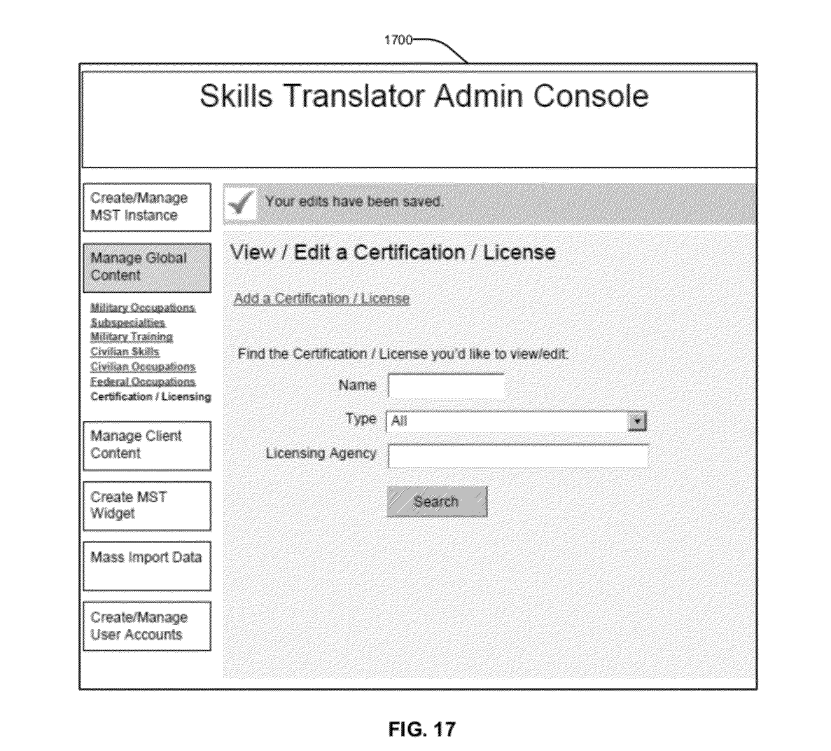

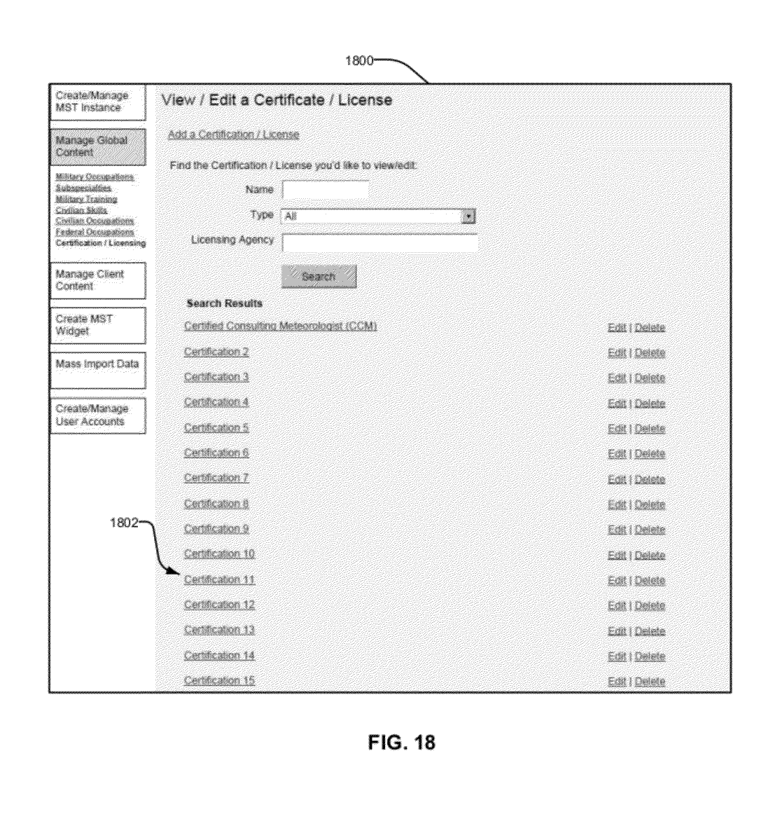

The skills translator admin console 300 also includes inputs for certifications or licenses. FIG. 17 illustrates a user interface 1700 in which an admin can search, view, or edit a certification or license. Examples of certifications or licenses include education certifications, computer skills certifications, security job certifications, nursing licenses, etc. The certifications and licenses can be stored and searched based on the name of the certificate or license, the type of certificate or license, and/or the licensing agency. An example screen shot of search results 1802 of certifications and licenses is shown in the user interface 1800 of FIG. 18.

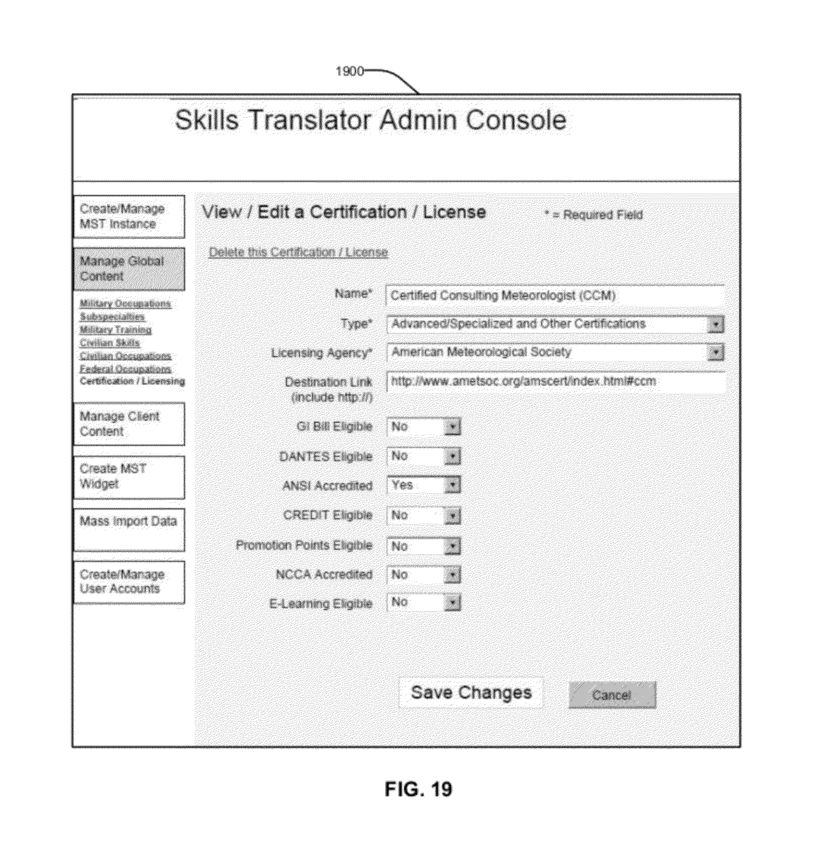

An admin can also create new certification or license. A record for a certification or license can be viewed and edited by the admin through the user interface 1900 shown in FIG. 19. The certification can be designated with various eligibility statuses that are available through military or civilian programs. In one example, a record can be viewed and edited for a certification named “Certified Consulting Meteorologist (CCM).” The admin can enter the type (“Advanced/Specialized and Other Certifications”), the licensing agency (“American Meteorological Society”), a destination link, and other relevant features (“ANSI Accredited”).

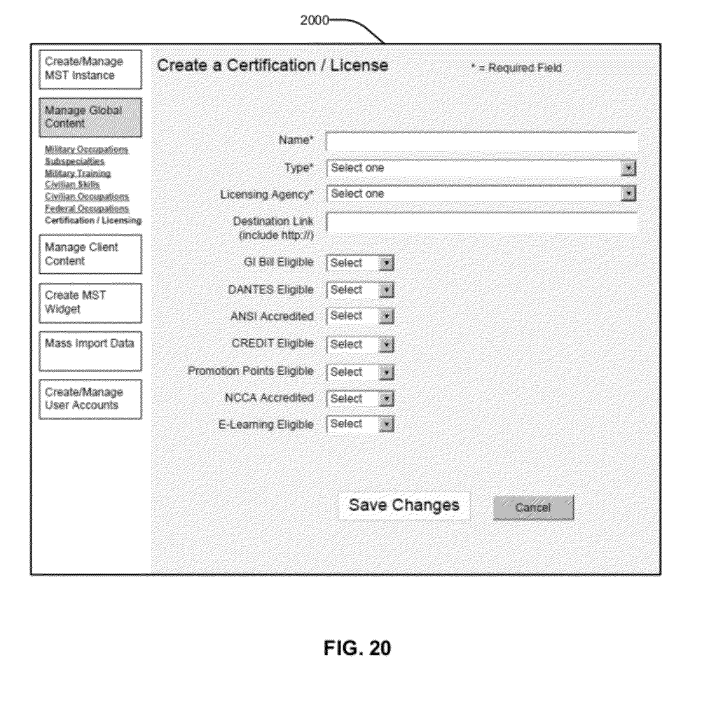

FIG. 20 illustrates an example screen shot of a user interface 2000 where the admin can create a certification or license. The following can be inputted into the record for the certificate or license: name, type, licensing agency, destination link, GI Bill eligibility, Defense Activity for Non-Traditional Education Support (DANTES) eligibility, American National Standards Institute (ANSI) accreditation, CREDIT eligibility, Promotion Points eligibility, NCCA (National Commission for Certifying Agencies) accreditation, or E-learning eligibility. The creation of these certifications makes them available for linking in the various military occupations and civilian occupations interfaces shown in FIGS. 5a-5b, 6, 12, and 13.

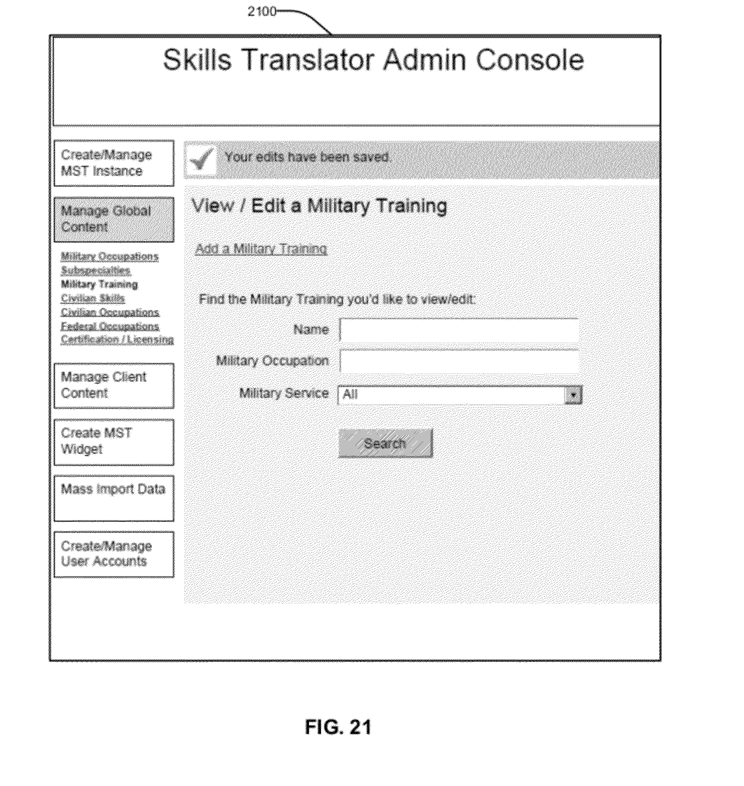

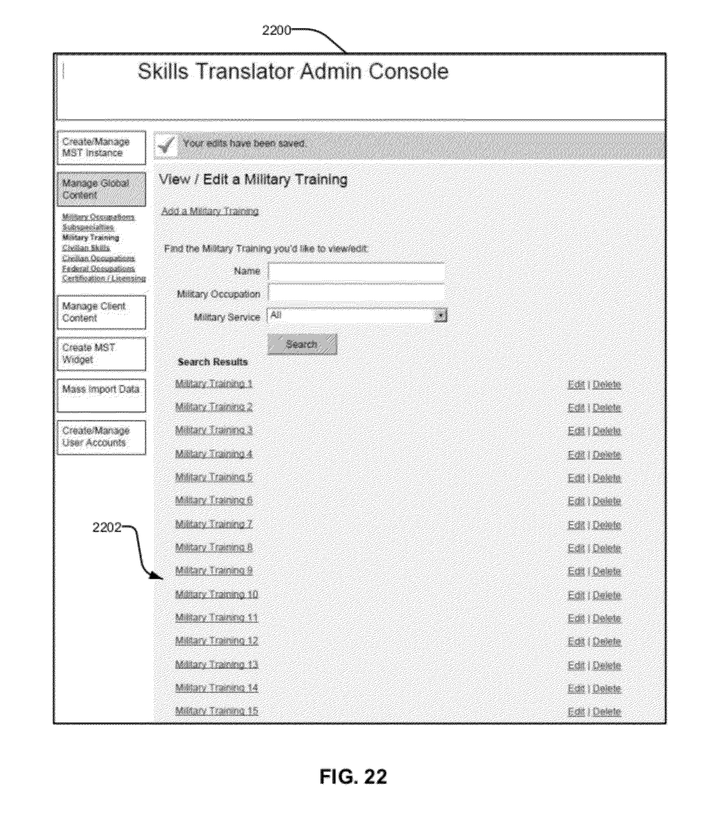

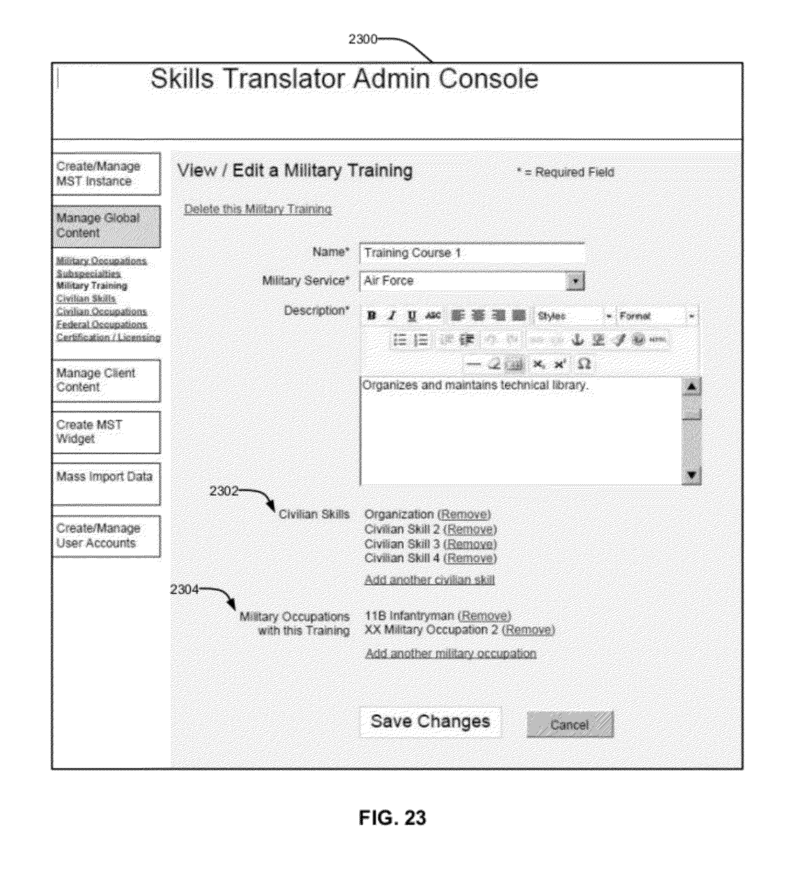

As shown in FIG. 21, a record 2100 for a military training can also be searched, viewed, and edited based on the name of the military training, associated military training, or military service. FIG. 22 shows an example user interface 2200 of a listing of search results 2202 of military trainings. The military training can be edited to be associated with civilian skills and military occupations. FIG. 23 shows an example user interface 2300 for a selected military training record, where the admin can edit the name, military service, description, related civilian skills, or military occupations. As described above, the addition of civilian skills 2302 or military occupations 2304 to the record of a military training maps the military training record to the selected civilian skills or military occupations, which results in a hierarchical definition for the associated military training, civilian skills, and/or military occupations.

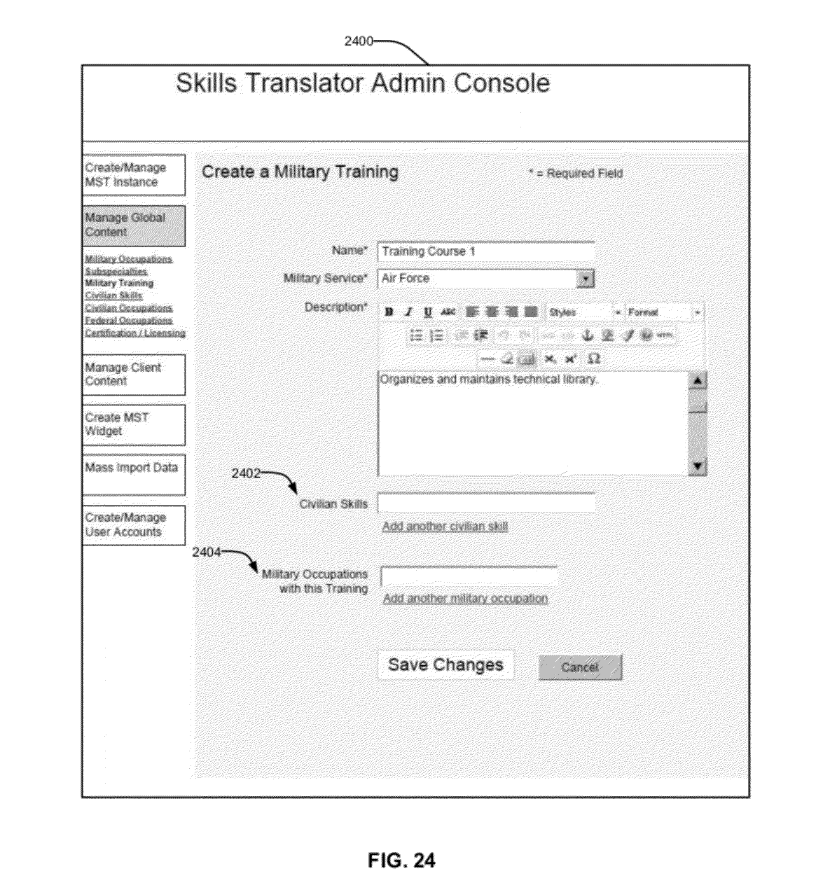

The admin can also create and edit records for military trainings. FIG. 24 shows a user interface for creating a record 2400 for a military training. The record can include the name of the military training, the military service, a description about the military training, related civilian skills 2402, and related military occupations 2404. Again, the creation of individual military training records makes them available for linking in the military occupations and skills, and civilian occupations and skills interfaces described above.

3. Management Platform for Employer Content

The military occupation and skills management system 120 includes facilities to manage employer content. An “employer” can be any third party, business, corporation, private group, civilian job resource, veteran's administration, federal entity or military entity. The content of the various databases described above can be edited to include civilian occupations, civilian jobs, and civilian skills that are relevant to the employer.

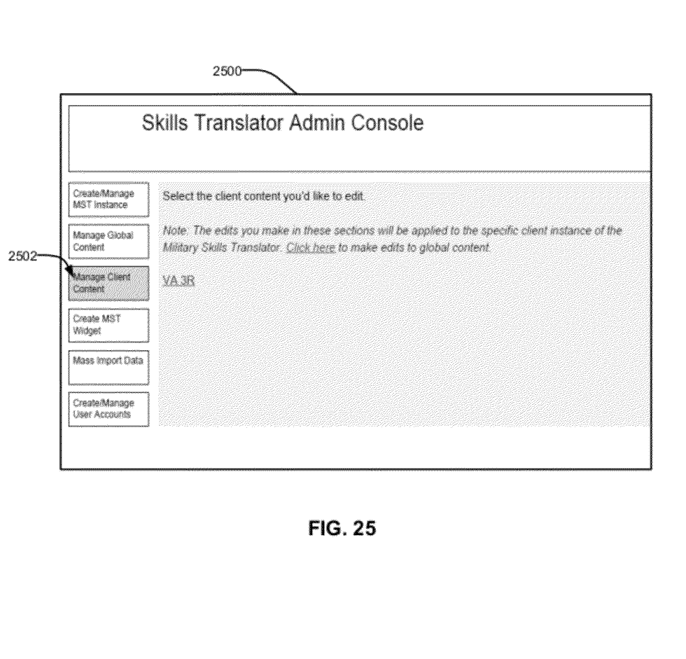

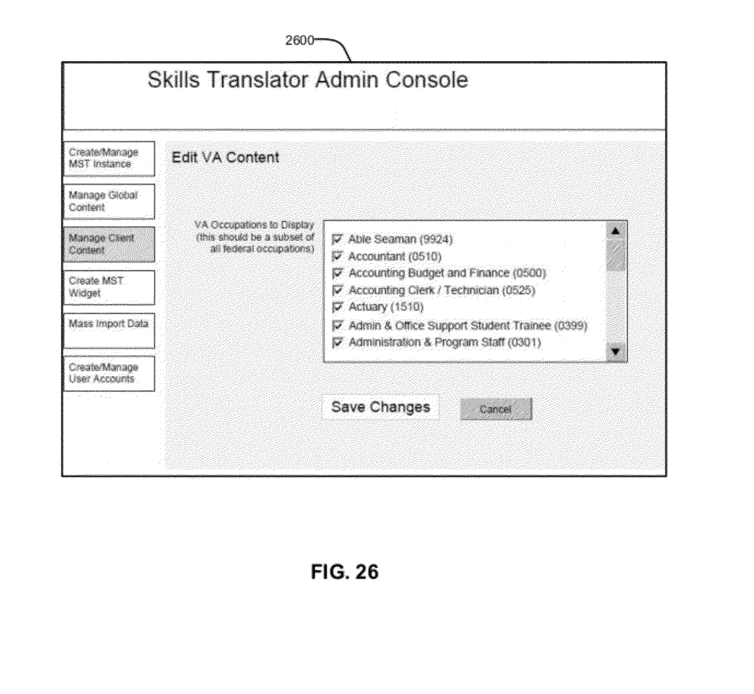

FIG. 25 illustrates a skills translator admin console 2500 with a tab 2502 for editing employer content. FIG. 26 shows an example of a user interface 2600 for editing employer content. Specifically, the occupations to display to a user can be edited to include occupations relevant for the employer, such as the VA for Vets. For example, the admin can edit veterans-related occupations to display to an end user.

From the foregoing, it should be understood that the military occupation and skills management system 120 allows one or more admins to curate both military occupations and civilian occupations, creating detailed, hierarchical mappings there between based on underlying skills. For example, an admin with expertise in a particular industry, such as aircraft manufacturing can use (or create) a set of civilian occupations in this industry and map these occupation and skills to corresponding military occupations, and vice versa, while an admin with expertise in electronics manufacturing and testing can likewise create a different set of mappings for civilian occupations in that industry.

More generally, it should be appreciated that the underlying database architecture, mapping and matching operations (next described) are not limited in application to translating military occupations to civilian occupations only. Rather, the system can be used to translating between any two occupational taxonomies that have hierarchical attributes (e.g., skills, training, certifications, licenses, duties, etc.). For example, the system can be used for mapping between a set of civilian occupations for a specific civilian industry (e.g., aircraft manufacturing), and a second civilian industry (e.g., automobile manufacturing). Similarly, the system can be used for mapping between the occupations of one specific employer with many different occupations (e.g., a large company such as Boeing or General Motors) and another company (e.g., Airbus or Ford Motor Co.).

II. Matching of Military Skills and Occupations

1. Translating MOS Code to Civilian Skills and Occupations for a User.

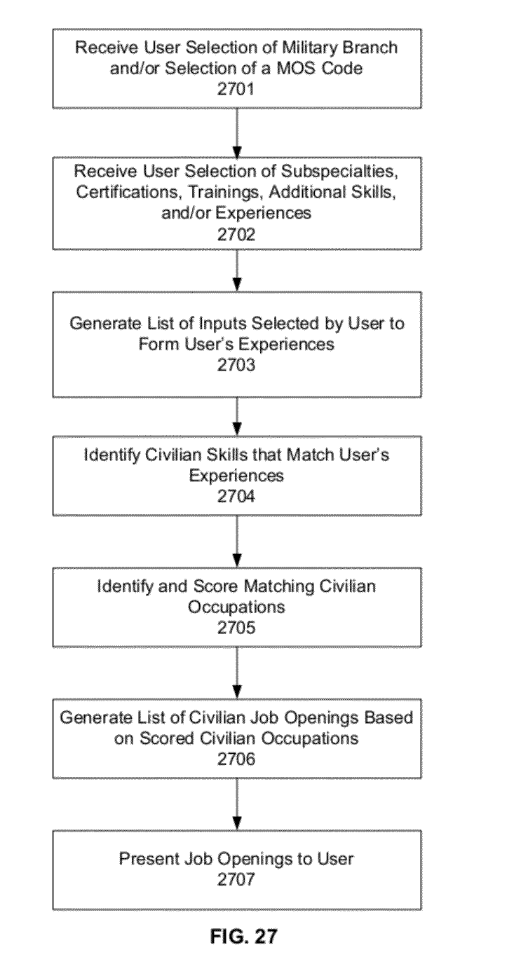

FIG. 27 illustrates a flow diagram that presents an overview of exemplary steps performed in the military skills translation process in the context of a user searching for a civilian occupation based on a military occupation. A user selection of military branch and/or a MOS code is received 2701. The user can select one or more MOS codes (multiple instances of MOS codes). A user selection of other subspecialties, certifications, trainings, additional skills and/or experiences can also be received 2702. For each received MOS code, the system can access the corresponding military occupation record, and from their accesses, each linked military duty, subspecialty, certification, training, civilian skill, and civilian occupation. For any of these records that have additional links (e.g., linked military occupations), the skills from such linked records are also retrieved. A final list of user experiences is generated 2703 from this set. In step 2704, civilian skills that match the user's experiences are identified. Next, one or more civilian occupations that match the civilian skills are identified 2705 and scored. A civilian occupation is matched based on the number of its included skills that match (intersect) with the user skills. Each civilian skill that matches a user skill can contribute a match value to the score. The match value can be unitary (e.g., 1), or a weighted value (e.g., [0,1]) associated with either or both of the civilian skill or the military skills; the weights can reflect the importance of the skill to the user or civilian occupation. The match values are then totaled for the civilian occupation to produce a final score.

Thus, in general form, a civilian occupation has a match score M where:

M=cᵢ*uᵢ for all inputs i.

Where cᵢ is the weight given to civilian skill i and u, is the weight given the matching user input i, and M is summed over all inputs. If the weights are (1), then the score M for a civilian occupation is simply the total number of matching skills.

From the scored civilian occupations, a final set is selected, for example as those having a score greater than a threshold score, or the top N (e.g., 10) scoring occupations or the like.

For each civilian occupation on the final list, a search is conducted across one or more of the jobs database for available job opening for that occupation, thereby generating 2706 a list of civilian job openings. Lastly, the job openings are presented 2707 to the user.

The user can edit the list of generated “user experiences” by adding additional inputs or removing inputs. The updated list of a user's experiences is then used to generate a new list of occupations and available job openings. The user can add additional search terms to the search to expand or narrow the search results.

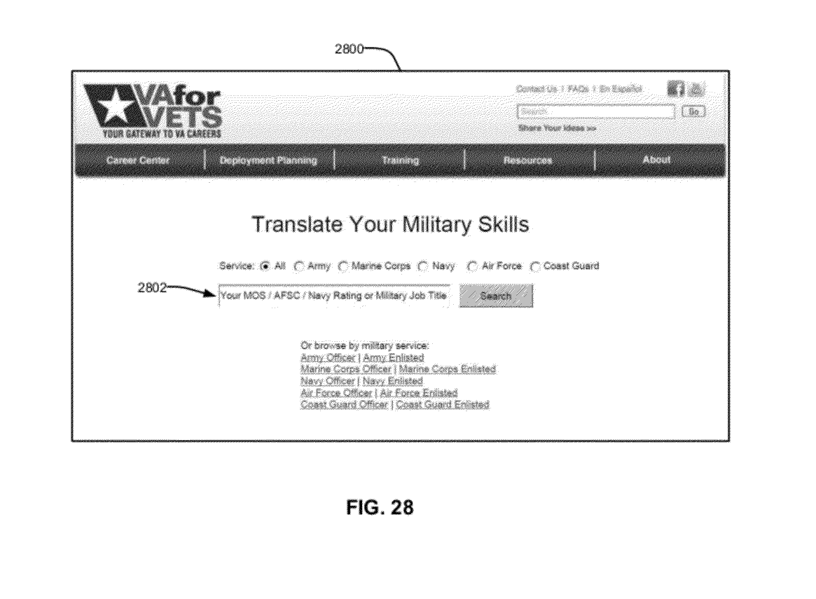

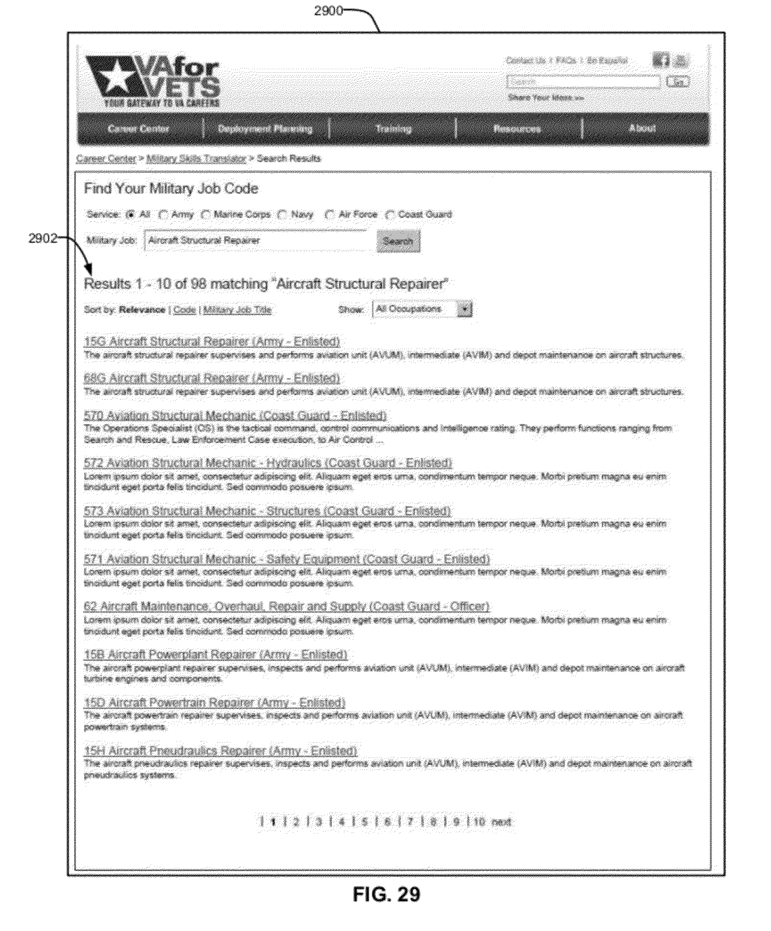

An example of the foregoing process is now described with respect to FIGS. 28-33. In FIG. 28, an example screen shot of a skills translator page 2800 is shown. The skills translator page includes a field 2802 for entering a MOS code, a military job title or other key words. The user can also choose to search all of the military services or just one military service. From the input information, the system constructs the appropriate query requests to the military skills translation module 121, which outputs the corresponding military occupations retrieved from the military occupations database 126 or the external military occupations database 140 or both. FIG. 29 shows the search results 2902 for a query of a military occupation on an example screen shot of a skills translator page 2900. In this example, the key words “Aircraft Structural Repairer” were searched. The skills translator engine 121 searches for all of the relevant military occupations that match the terms, keywords, or title and generates a relevant list. The list can be sorted by relevance, code, or military job title. The user can select the appropriate military occupation from the displayed search results.

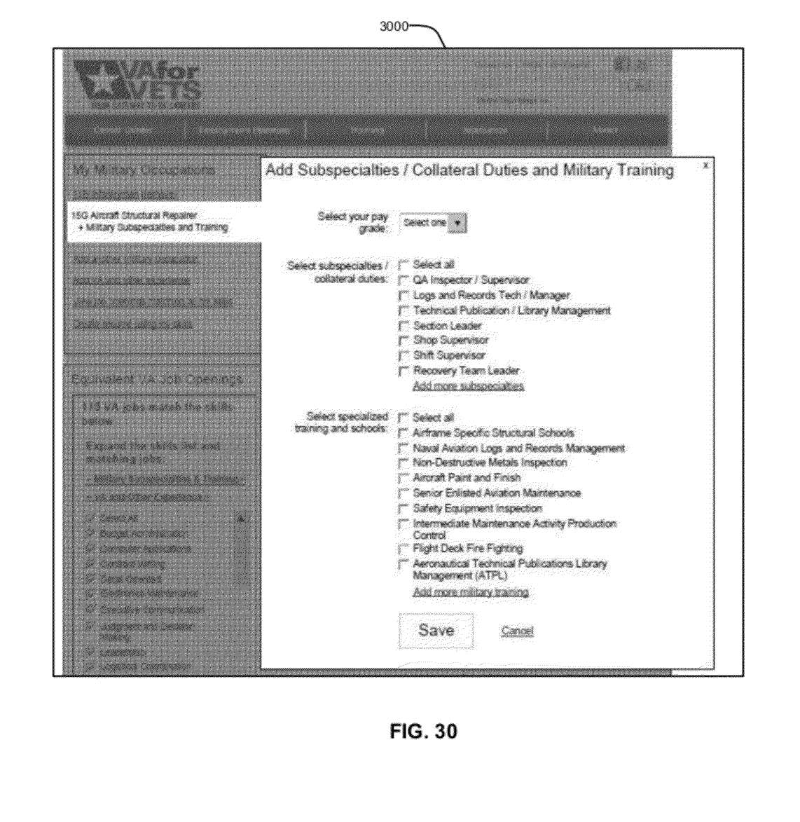

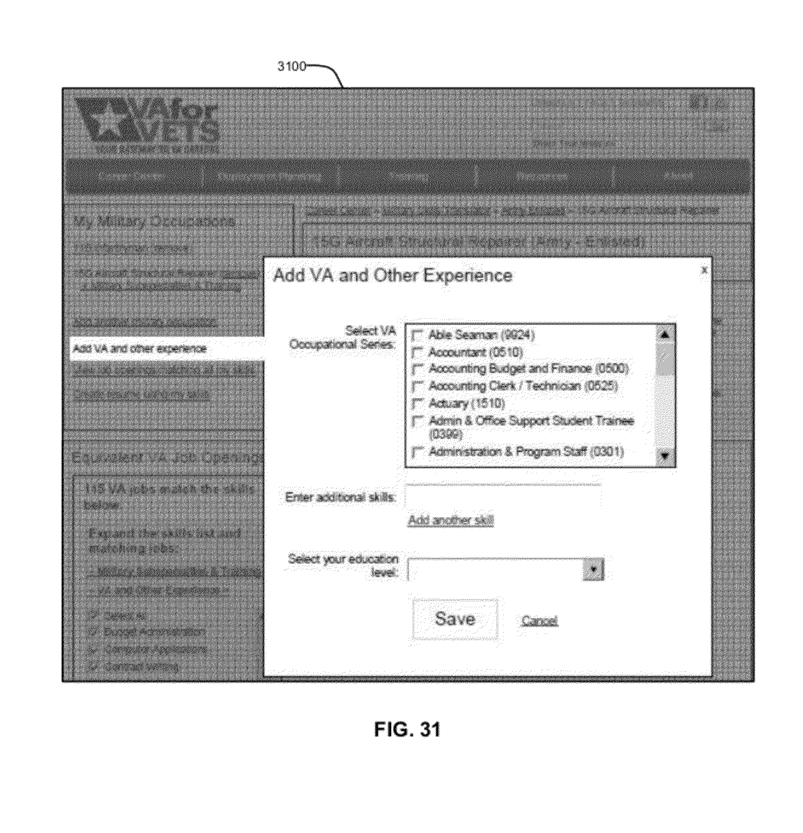

Once a military occupation has been selected by the user, the user can add additional skills, collateral duties, subspecialties, or military trainings. FIG. 30 illustrates a screen shot of an exemplary web page 3000 for adding additional skills and information to the user's search. In this example, a user can add a pay grade, collateral duties, subspecialties, and/or specialized trainings or schools to the search. In FIG. 31, other experiences, additional skills, and/or an education level can be added to the user's search criteria from the exemplary web page 3100.

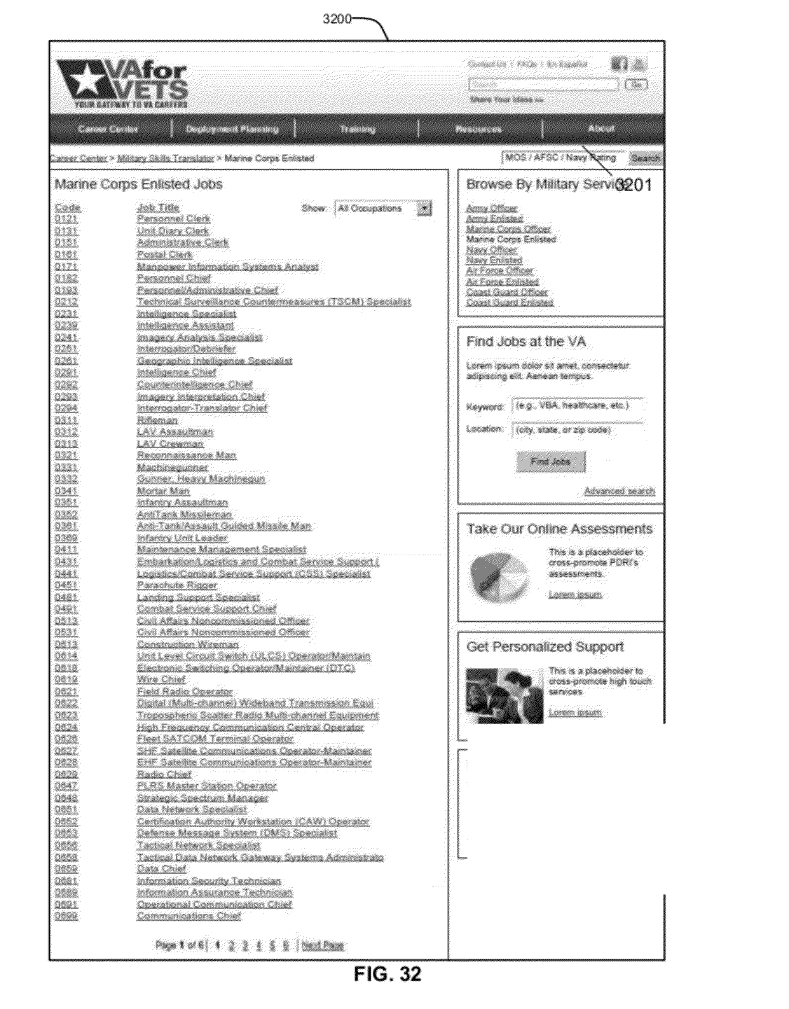

A user may also browse for military occupations based on the military service and job title. As shown in FIG. 32, the user can select and browse military job titles on the web page 3200 from the following categories of military services: Army Officer, Army Enlisted, Marine Corps Officer, Marine Corps Enlisted, Navy Officer, Navy Enlisted, Air Force Officer, Air Force Enlisted, Coast Guard Officer, or Coast Guard Enlisted. From the selected military service, a user can search and select from a list of jobs and related MOS codes. For example, a user can select a link to browse the Marine Corps Enlisted Jobs, which produces a comprehensive list of Marine Corps Enlisted Job titles.

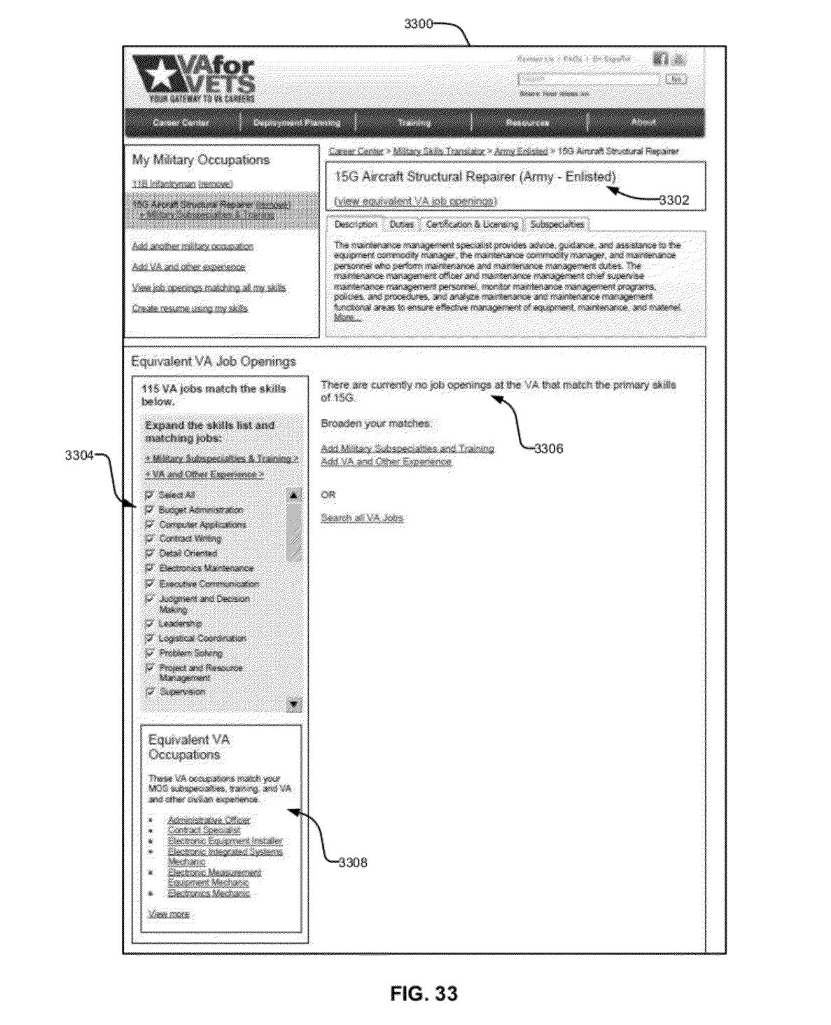

Based on the user's selection of a MOS code, other skills and subspecialties, search results for matching civilian occupations and civilian skills are generated and compiled using the methods described above, such that the civilian occupations and civilian skills match the user's experiences (user inputs for military duties, subspecialties, training, etc.). Furthermore, a list of civilian job openings can be generated based on the matching civilian occupations and skills FIG. 33 illustrates search results for VA job openings based on a user's selection 3302 of a military occupation (“15G Aircraft Structural Repairer (Army-Enlisted)”) and the user's skills list 3304, which includes additional military subspecialties, training and other experiences. In this example, no job openings were found 3306 in a search of the VA job database. In some embodiments, other equivalent civilian occupations 3308 can be presented to the user, in addition to the selected MOS code.

Any of the methods and systems described herein can be applied to federal occupations or jobs.

Additional Considerations

The present invention has been described in particular detail with respect to several possible embodiments. Those of skill in the art will appreciate that the invention may be practiced in other embodiments. It is also appreciated that embodiments of the invention may be practiced in other communications network environments that include components to enable the data collection and data display steps, as described above.

The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs.

Furthermore, it has also proven convenient at times, to refer to these arrangements of operations as modules or by functional names, without loss of generality. In this description, the term “module” refers to computational logic for providing the specified functionality. A module can be implemented in hardware, firmware, and/or software. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of the service 100, loaded into memory, and executed by the one or more processors of the service's computers.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be persistently stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A computer-implemented method for translating a military occupation specialty (MOS) code to a civilian occupation for a user, comprising:
receiving a MOS code, wherein the MOS code is associated with a plurality of military duties;
generating a set of user inputs comprising the plurality of military duties associated with the MOS code;
translating the set of user inputs to one or more civilian skills; and
identifying one or more civilian occupations associated with the one or more civilian skills.

2. The computer implemented method of claim 1, further comprising:
generating a list of job openings based on the identified civilian occupation; and
presenting the list of job openings to the user.

3. The computer implemented method of claim 1, further comprising receiving a subspecialty from the user.

4. The computer implemented method of claim 1, further comprising receiving a military training from the user.

5. The computer implemented method of claim 1, further comprising receiving a certification or license from the user.

6. The computer implemented method of claim 1, further comprising receiving additional skills from the user.

7. The computer implemented method of claim 1, wherein the set of user inputs comprises a subspecialty, a military training, a certification, a license, an additional skill, or a work experience.

8. The computer implemented method of claim 1, further comprising generating a score based on the matching of the set of user inputs to the one or more civilian skills.

9. The computer implemented method of claim 8, wherein the score must exceed a pre-determined threshold to match the set of user inputs to the one or more civilian skills.

10. The computer implemented method of claim 1, further comprising allowing the user to edit the set of user inputs.

11. The computer implemented method of claim 1, further comprising:
creating a record for the MOS code;
mapping a MOS code to a civilian skill.

12. The computer implemented method of claim 1, further comprising:
creating a record for the MOS code;
mapping a MOS code to a civilian occupation.

13. The computer implemented method of claim 1, further comprising:
creating a record for a civilian occupation;
mapping a MOS code to the civilian occupation.

14. A computer-readable storage medium storing executable computer program instructions for translating a military occupation specialty (MOS) code to a civilian occupation for a user the computer program instructions comprising:
receiving a MOS code, wherein the MOS code is associated with a plurality of military duties;
generating a set of user inputs comprising the plurality of military duties associated with the MOS code;
translating the set of user inputs to one or more civilian skills; and
identifying one or more civilian occupations associated with the one or more civilian skills.

15. The computer-readable storage medium of claim 14, further comprising:
generating a list of job openings based on the identified civilian occupation; and
presenting the list of job openings to the user.

16. The computer implemented method of claim 1, further comprising receiving a subspecialty from the user.

17. The computer-readable storage medium of claim 14, further comprising receiving a military training from the user.

18. The computer-readable storage medium of claim 14, further comprising receiving a certification or license from the user.

19. The computer-readable storage medium of claim 14, further comprising receiving additional skills from the user.

20. The computer-readable storage medium of claim 14, wherein the set of user skills comprises a subspecialty, a military training, a certification, a license, an additional skill, or a work experience.

21. The computer-readable storage medium of claim 14, further comprising generating a score based on the matching of the set of user inputs to the one or more civilian skills.

22. The computer-readable storage medium of claim 21, wherein the score must exceed a pre-determined threshold to match the set of user inputs to the one or more civilian skills.

23. The computer-readable storage medium of claim 14, further comprising allowing the user to edit the set of user inputs.

24. The computer-readable storage medium of claim 14, further comprising:
creating a record for the MOS code;
mapping a MOS code to a civilian skill.

25. The computer-readable storage medium of claim 14, further comprising:
creating a record for the MOS code;
mapping a MOS code to a civilian occupation.

26. The computer-readable storage medium of claim 14, further comprising:
creating a record for the civilian occupation;
mapping a MOS code to the civilian occupation.

27. A computer system for translating a military occupation specialty (MOS) code to a civilian occupation for a user, the system comprising:
a computer processor; and
a computer program executable by the computer processor and performing actions comprising:
receiving a MOS code, wherein the MOS code is associated with a plurality of military duties;
generating a set of user inputs comprising the plurality of military duties associated with the MOS code;
translating the set of user inputs to one or more civilian skills; and
identifying one or more civilian occupations associated with the one or more civilian skills.

28. The system of claim 27, further comprising:
generating a list of job openings based on the identified civilian occupation; and
presenting the list of job openings to the user.

29. The computer implemented method of claim 1, further comprising receiving a subspecialty from the user.

30. The system of claim 27, further comprising receiving a military training from the user.

31. The system of claim 27, further comprising receiving a certification or license from the user.

32. The system of claim 27, further comprising receiving additional skills from the user.

33. The system of claim 27, wherein the set of user inputs comprises a subspecialty, a military training, a certification, a license, an additional skill, or a work experience.

34. The system of claim 27, further comprising generating a score based on the matching of the set of user inputs to the one or more civilian skills.

35. The system of claim 34, wherein the score must exceed a pre-determined threshold to match the set of user inputs to the one or more civilian skills.

36. The system of claim 27, further comprising allowing the user to edit the set of user inputs.

37. The system of claim 27, further comprising:
creating a record for the MOS code;
mapping a MOS code to a civilian skill.

38. The system of claim 27, further comprising:
creating a record for the MOS code;
mapping a MOS code to a civilian occupation.

39. The system of claim 27, further comprising:
creating a record for a civilian occupation;
mapping a MOS code to the civilian occupation.
